(19) United States
(12) Patent Application Publication
(10) Pub. No.: US 2012/0158432 A1
(43) Pub. Date: Jun. 21, 2012

(54) Patient Information Documentation And Management System

(76) Inventors: Uday Jain, Lawrenceville, NJ (US); Manli Zhu, Pearl River, NY (US); Yan Yin, Lake Hiawath, NJ (US); Qi Li, New Providence, NJ (US)

(21) Appl. No.: 13/323,798

(22) Filed: Dec. 12, 2011

Related U.S. Application Data
(60) Provisional application No. 61/459,546, filed on Dec. 15, 2010.

(51) Int. Cl. G06Q 50/24

(52) U.S. Cl. 705/3

(57) ABSTRACT

A method and system for documenting and managing patient information in real time for accurate medical examination and treatment of a patient is provided. An information carrier device that stores patient information is provided to the patient. A data extraction unit extracts the stored patient information from the information carrier device and transmits the extracted patient information to a patient information processing system. A recording unit records observational data comprising medical examination information and information on treatment prescribed for the patient. The patient information processing system processes and analyzes the patient information received from the information carrier device and/or the data extraction unit and the observational data extracted from the recording unit, generates a medical examination report in one or more of multiple formats, and transmits the medical examination report in one or more formats to the information carrier device for updating the patient information in the information carrier device.

### CROSS REFERENCE TO RELATED APPLICATIONS

This application claims the benefit of provisional patent application No. 61/459,546 titled “Medical care voice documentation system”, filed on Dec. 15, 2010 in the United States Patent and Trademark Office.

The specification of the above referenced patent application is incorporated herein by reference in its entirety.

### BACKGROUND

During a medical emergency, for example, during a war, it is critical for medical personnel who treat a patient such as an injured soldier to have access to the medical history of the patient. For example, medical personnel need to be apprised of prior medical conditions of the patient before proceeding with treatment. Moreover, medical personnel should be able to record the steps of the treatment and observations concerning the patient's condition so that a medical treatment facility at the next level of treatment is able to access the information on the initial treatment provided to the patient and treat the patient accordingly.

Medical information storage devices that store medical information of a patient provide inadequate access of patient information to medical personnel. The existing medical information storage devices do not provide a facility for updating the patient information in real time and for providing access to the updated patient information in different formats during transport of the patient to a medical treatment facility. This may lead to delays as well as incomplete reporting of the patient's medical condition and treatment administered to the patient during transport of the patient to medical personnel at the medical treatment facility. Moreover, existing medical information storage devices are functionally limited to storage of patient information and do not provide a facility for recording real time patient information in multiple content formats directly, which may contribute to the delay in documenting real time patient information in these medical information storage devices.

Furthermore, existing medical information storage devices are constrained by a lack of availability and compatibility of communication interfaces that enable access of patient information by computing devices of medical personnel. The medical information storage devices are rendered ineffective when the computing devices do not support and are therefore incompatible with the communication interfaces of the medical information storage devices. Therefore, there is a need for enabling communication between a medical information storage device and the computing devices of medical personnel via multiple compatible interfaces supported by multiple communication protocols.

Furthermore, existing medical information storage devices are power dependent. The durability of the medical information storage devices depends on the quality of batteries employed by these medical information storage devices. The medical information storage devices may not function in an extreme environment, for example, in a wartime environment when their batteries are exhausted of power. Therefore, there is a need for a power independent medical information storage device that retains patient information and allows extraction of the patient information without being powered by batteries.

Furthermore, conventional methods of documentation have largely focused on manual paper based documentation. However, it is difficult for medical personnel to complete paper documentation in an emergency situation, since sufficient time may not be available to do so. For example, in a wartime environment, the focus is on achieving mission objectives, saving lives, administering emergency treatment to injured soldiers, arranging for rapid evacuation of casualties and wounded soldiers, etc., in a short span of time rather than documenting the treatment provided to the patient. Moreover, the fact that paper documentation is vulnerable to damage in a wartime environment and could be lost, incomplete, inaccurate or illegible, due to noise and chaos in the emergency situation, compounds the problem. Moreover, in cases of electronic documentation, in the absence of a strong wireless network, transmission of patient information is restricted and the medical information of the patient may not be accessible on time at the medical treatment facility. Furthermore, in the absence of strong data encryption systems, there is a likelihood of sensitive personal information and the patient's identity being compromised.

Typical methods for recording information, for example, audio content are often rendered ineffective in high noise environments due to an inability to adapt to the high noise environments. Furthermore, existing methods for recording information are often constrained by an inability to process the recorded information to improve the quality of the recorded information and/or to retrieve useful information from the recorded information within a very short duration of time. Recording is particularly difficult in a high noise environment such as a wartime environment. Therefore, there is a need for a method and a system that operate effectively under a high noise environment without delays in providing access to the recorded information, and that imposes fewer constraints on users such as medical personnel who need to constantly move around in the high noise environment. Moreover, there is a need for a method and a system that can automatically record and render patient information with timestamps, with minimal user intervention.

Hence, there is a long felt but unresolved need for a patient information documentation and management system that documents, maintains, and manages patient information in one or more formats in real time, which enables medical personnel to easily and quickly access and update medical records of the patient as the patient is treated and transferred through the echelons of care. Moreover, there is a need for a method and system that facilitates accurate, non-intrusive, hands-free, paperless, and quick documentation of the medical condition of the patient during an emergency. Furthermore, there is a need for a method and system that conveniently records observational data provided by the medical personnel in real time, automatically time stamps the recorded observational data, enhances the quality of the recorded observational data, and quickly updates the recorded observational data along with the patient information, with minimal user intervention. Furthermore, there is a need for a method and system that provides a flexible, power independent, multi-interfacing mechanism that enables transmission of the patient information and the recorded observational data in one or more formats to the computing devices of medical personnel. Furthermore, there is a need for a method and a system that helps patients to securely carry up-to-date records of their medical history at all times through the echelons of care.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The method and system disclosed herein addresses the above mentioned needs for a patient information documentation and management system that documents, maintains, and manages patient information in one or more formats in real time, for accurate medical examination and treatment of a patient during an emergency. As used herein, the term “patient information” refers to information pertaining to a patient comprising, for example, the patient's identification information, the patient's biometric information, the patient's medical records, personal information, etc. The method and system disclosed herein enables medical personnel to easily and quickly access and update medical records of the patient as the patient is treated and transferred through the echelons of care. The method and system disclosed herein facilitates accurate, non-intrusive, hands-free, paperless, and quick documentation of the medical condition of the patient during an emergency, thereby enabling appropriate and timely patient care. The patient information documentation and management system disclosed herein enables accurate and rapid documentation of the treatment by a first responder close to the point of injury, thereby enhancing the quality of care the patient receives and speeds up the patient's recovery. The patient information documentation and management system disclosed herein is used, for example, for combat casualty care, civilian medical care, etc.

Moreover, the method and system disclosed herein enables convenient recording of observational data by the medical personnel in real time, automatic time stamping of the recorded observational data, enhancing of the quality of the recorded observational data, and quick updating of the recorded observational data along with the patient information, with minimal user intervention. Furthermore, the method and system disclosed herein provides a flexible, power independent, multi-interfacing mechanism that enables transmission of the patient information and the recorded observational data in one or more formats to the computing devices of medical personnel. The method and system disclosed herein helps patients to securely carry up-to-date records of their medical history at all times through the echelons of care.

The patient information documentation and management system disclosed herein comprises an information carrier device, a data extraction unit, a recording unit, and a patient information processing system. The data extraction unit and the patient information processing system electronically communicate with the information carrier device, for example, by a wired mode of communication, a wireless mode of communication via a communication network, or a combination thereof. The information carrier device is configured as a non-volatile memory card that stores the patient information independent of power. The information carrier device can be worn as a tag by an individual. For example, in a wartime environment, a soldier may wear the information carrier device as a tag on the war front. The information carrier device is water proof, dust proof, and power independent, thereby allowing maintenance of the information carrier device in rugged and unfavorable conditions for long periods of time.

The information carrier device comprises a data storage unit that stores the patient information, a medical examination report, information on medical situations, triage information, etc., in one or more of multiple individual and combined formats in the information carrier device. As used herein, the term “format” refers to a configuration of content and/or a file in which the patient information, observational data, the medical examination report, information on medical situations, triage information, etc., can be stored and rendered for observation and interpretation. The formats comprise, for example, a text format, a portable document format, an audio format, a video format, an audiovisual format, an image format, an animation format, a multimedia format, a rich content format, etc. The triage information comprises instructions for categorizing and determining priorities of patients' treatments based on severity of the patients' conditions, treatment instructions, etc. The data storage unit is accessible via a user interface, for example, through an audio based access, a manual access, etc., for enabling accurate medical examination and treatment of the patient. The information carrier device retains the stored information and allows extraction of the stored information without being powered by batteries.

In an embodiment, the method and system disclosed herein provides a knowledge base accessible via the data storage unit of the information carrier device and/or via the communication network. The knowledge base stores information on medical situations and triage information in one or more of the formats accessible through an audio based access and/or a manual access for enabling accurate medical examination and the treatment of the patient. In an embodiment, the information carrier device receives a query from a responder for instructions on the treatment of the patient. As used herein, the term “responder” refers to a person at a point of first care of a patient, who performs a preliminary assessment of a condition of the patient and administers initial treatment to the patient. The responder is, for example, a certified first responder, a paramedic, first aid personnel, etc. The information carrier device performs data recognition on the query received from the responder for extracting keywords from the query. The information carrier device performs a search for triage information in the knowledge base using the extracted keywords and renders the triage information in one or more of multiple formats, for example, an audio format, a video format, an audiovisual format, a text format, etc., on a user interface of the information carrier device for enabling treatment of the patient by the responder.

In an embodiment, the information carrier device monitors biomedical signals of the patient for verifying vital signs of the patient and biometrically tracking the identity of the patient. The biomedical signals are, for example, electrocardiographic (ECG) signals, electroencephalographic (EEG) signals, electroneurographic (ENG) signals, electromyogram (EMG) signals, blood pressure signals, etc. The vital signs are measures of physiological statistics, for example, body temperature, pulse rate, blood pressure, respiratory rate, etc., of the patient that enable assessment of basic body functions of the patient. In an embodiment, the information carrier device generates an alarm notification on detecting a divergence of the vital signs of the patient from preconfigured settings in the information carrier device. The information carrier device also generates an alarm notification on detecting a loss of signal contact, for example, between the information carrier device and external responder devices, and/or on detecting a misassociation between the information carrier device and the patient.

The data extraction unit extracts the stored patient information from the information carrier device. In an embodiment, the data extraction unit can be connected to the information carrier device via their respective communication interfaces to extract the stored patient information from the information carrier device. The data extraction unit, in electronic communication with the patient information processing system operated by medical personnel, transmits the extracted patient information to the patient information processing system. The data extraction unit electronically communicates with the patient information processing system, for example, by a wired mode of communication, a wireless mode of communication via a communication network, or a combination thereof. In an embodiment, the patient information processing system directly extracts the patient information from the information carrier device, for example, by a wired mode of communication, a wireless mode of communication via a communication network, or a combination thereof.

The recording unit of the patient information documentation and management system disclosed herein records observational data comprising medical examination information and information on treatment prescribed for the patient. In an embodiment, the recording unit comprises an array of sound sensors positioned in an arbitrary configuration for receiving the observational data of the patient. The recording unit is, for example, an audio or voice recorder, a video recorder, a text content recorder, an image capture device, a multimedia recorder, or any combination thereof. The recorded observational data comprises, for example, one or more of audio content, video content, text content, audiovisual content, image content, multimedia content, and any combination thereof. In an embodiment, the recording unit and/or the patient information processing system recognize and transform one or more of the audio content, the video content, the text content, the audiovisual content, the image content, the multimedia content, or any combination thereof, from the recorded observational data into one or more of multiple content formats, for example, a text content format, an audio content format, a video content format, an audiovisual content format, an image content format, a multimedia content format, etc.

In an embodiment, the recording unit is configured to establish bidirectional remote communication with a remote medical facility to transmit the recorded observational data to the remote medical facility and receive instructions from the remote medical facility to determine triage information for the patient. The recording unit stores the triage information in the information carrier device, for example, via a wired mode of communication, a wireless mode of communication via a communication network, a combination of a wired mode of communication and a wireless mode of communication, etc. In an embodiment, the recording unit performs one or more of echo cancellation, audio compression and decompression, image compression and decompression, video compression and decompression, etc., of the recorded observational data for establishing bidirectional remote communication between the recording unit and the remote medical facility.

In an embodiment, the recording unit automatically appends timestamps to the recorded observational data during the recording of the observational data by the recording unit. The recording unit converts the appended timestamps to an audio format to enable audio playback of the appended timestamps along with the recorded observational data. In an embodiment, the recording unit is a standalone unit that communicates with the patient information processing system. In another embodiment, the recording unit is integrated in the patient information processing system for recording and playback of the observational data. In another embodiment, the information carrier device is provisioned with the recording unit and one or more interface elements. The interface elements on the information carrier device enable activation of the recording unit for recording and playback of the observational data. The recording unit electronically communicates with the patient information processing system, for example, by a wired mode of communication, a wireless mode of communication via a communication network, or a combination thereof. The patient information processing system operated by medical personnel extracts the recorded observational data from the recording unit.

The patient information processing system processes and analyzes the patient information received from the information carrier device and/or the data extraction unit, and the observational data extracted from the recording unit. In an embodiment, the recording unit and/or the patient information processing system enables improvement of signal-to-noise ratio and suppresses background noise of the recorded observational data.

The patient information processing system generates a medical examination report in one or more of multiple individual and combined formats based on the processing and the analysis of the patient information received from the information carrier device and/or the data extraction unit, and the recorded observational data extracted from the recording unit. In an embodiment, the patient information processing system automatically fills the medical examination report and predefined forms using the patient information received from the information carrier device and/or the data extraction unit, and the recorded observational data extracted from the recording unit. In an embodiment, the patient information and the generated medical examination report are secured in the information carrier device, the data extraction unit, and the patient information processing system, for example, using an encryption mechanism.

In an embodiment, the patient information processing system selectively extracts information on health conditions and treatment administered to the patient from each recording of the observational data for generating a health record for each recording of the observational data. The health record comprises selective information on the health condition and treatment administered to the patient. Furthermore, the patient information processing system integrates the selectively extracted information across multiple recordings of the observational data of the patient for ensuring that implicit information recorded on the health conditions and the treatment administered to the patient in one or more of the recordings of the observational data is explicitly recorded in each generated health record. The patient information processing system extracts keywords from the recorded observational data, tags the extracted keywords to the generated health record associated with the recorded observational data, and stores the generated health record and the recorded observational data, for example, in a medical information database of the patient information processing system, a data storage unit of the information carrier device, etc., for enabling an expedited retrieval of the generated health record and the recorded observational data using the keywords.

In an embodiment, the patient information processing system collates multiple health records of multiple patients stored in the medical information database of the patient information processing system based on the extracted keywords, for tracking injuries of the patients and medical reactions to the treatment and medicines administered to the patients.

The patient information processing system transmits the medical examination report generated by the patient information processing system in one or more of the formats, to the information carrier device for updating the patient information in the information carrier device. A remote medical facility can extract the updated patient information from the information carrier device for updating the patient information at the remote medical facility, for example, by directly interfacing the information carrier device to a patient information processing system at the remote medical facility, for example, via a wired mode of communication, a wireless mode of communication, or a combination thereof, or by utilizing the data extraction unit to extract the updated patient information from the information carrier device via a wired mode of communication, a wireless mode of communication, or a combination thereof, and to then transmit the extracted patient information to the patient information processing system via a wired mode of communication, a wireless mode of communication, or a combination thereof. The patient information processing system at the remote medical facility may directly extract the updated patient information from the information carrier device, for example, via a wired interface such as the universal serial bus (USB) interface, a universal asynchronous receiver/transmitter (UART) interface, a recommended standard 485 (RS-485) interface, a customized wired interface, etc.

In an embodiment, the patient information processing system transmits the generated medical examination report in one or more of the formats to the remote medical facility via the communication network for updating the patient information at the remote medical facility. The generation of the medical examination report in one or more of the formats and the updation of the patient information in the information carrier device enable the documentation and the management of the patient information in real time for accurate medical examination and treatment of the patient.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a method for documenting and managing patient information in real time for accurate medical examination and treatment of a patient.

FIG. 2 exemplarily illustrates a method for processing and analyzing patient information and recorded observational data performed by a patient information processing system.

FIG. 3 exemplarily illustrates a method for improving signal-to-noise ratio and suppressing background noise of recorded observational data.

FIG. 4 exemplarily illustrates a method for securing recorded observational data comprising audio content for enabling a secure transmission of the recorded observational data to the patient information processing system over a communication network.

FIGS. 5A-5D exemplarily illustrate a system for documenting and managing patient information in real time for accurate medical examination and treatment of a patient.

FIG. 6 exemplarily illustrates the architecture of a computer system employed for documenting and managing patient information in real time for accurate medical examination and treatment of a patient.

FIG. 7 exemplarily illustrates a screenshot of a user interface rendering a medical examination report generated by the patient information processing system.

FIG. 8 exemplarily illustrates a block diagram of a system employed by the recording unit for improving signal-to-noise ratio of the recorded observational data.

FIGS. 9A-9G exemplarily illustrate graphical representations of results of applying a spectral subtraction algorithm to the recorded observational data.

FIGS. 10A-10B exemplarily illustrate graphical representations of signals obtained on applying a cochlear transform algorithm to the recorded observational data for suppressing background noise and improving the signal-to-noise ratio of the recorded observational data.

FIGS. 11A-11B exemplarily illustrate block diagrams of systems for suppressing background noise and improving the signal-to-noise ratio of the recorded observational data.

FIGS. 12A-12C exemplarily illustrate a flowchart comprising the steps for documenting and managing patient information in real time for accurate medical examination and treatment of a patient in an emergency situation.

### DETAILED DESCRIPTION OF THE INVENTION

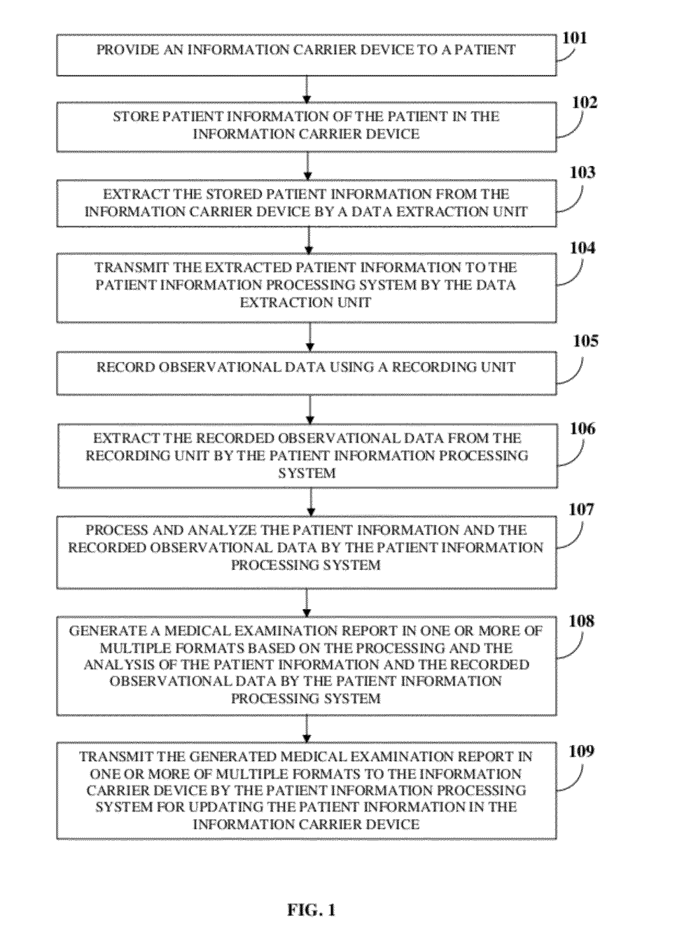

FIG. 1 illustrates a method for documenting and managing patient information in real time for accurate medical examination and treatment of a patient. As used herein, the term “patient information” refers to information pertaining to a patient comprising, for example, the patient's identification information, the patient's biometric information, the patient's medical records, the patient's personal information, etc. The patient's medical records comprise a complete documentation of the patient's medical history including the patient's medical condition and diseases. The medical records comprise, for example, a list of the patient's past ailments, history of allergies towards specific drugs and environmental agents, immunization status, laboratory test results, vital signs, medical treatment, drugs taken, etc. The patient's biometric information comprises measurable biological characteristics, for example, fingerprints, palm prints, color of a patient's iris, etc., used to identify the patient based on the patient's physical trait or behavioral characteristics. The patient's personal information comprises, for example, name, age, contact details of the patient, etc.

The method disclosed herein provides 101 an information carrier device to the patient. The information carrier device is configured, for example, as a non-volatile memory card that stores 102 the patient information independent of power and is wearable by the patient. The patient, for example, a soldier, may wear the information carrier device as a tag around his/her neck. The patient information stored in the information carrier device provides a complete documentation of the patient's medical history, which enables medical personnel in emergency situations to provide accurate and quick treatment. As used herein, the term “medical personnel” refers to one or more persons qualified to examine a patient and provide at least a first level of treatment to the patient. Medical personnel comprise, for example, qualified medical professionals, emergency medical technicians, paramedics, emergency physicians, first responders, battlefield corpsmen attending to injured soldiers at the war front, ambulance attendants supervising the condition of a soldier during transport of the soldier to a remote medical treatment facility, doctors at the medical treatment facility, etc. The information carrier device is, for example, a bodily worn device, can have the size of an electronic identification tag, and may be affixed to an electronic identification tag of the patient. The information carrier device may also be manually carried by the patient, affixed to the patient, or affixed to an accessory that the patient carries or wears such as a pendant or a bracelet.

In an embodiment, the information carrier device monitors biomedical signals of the patient for verifying vital signs of the patient and biometrically tracking the identity of the patient. The biomedical signals are, for example, electrocardiographic (ECG) signals, electroencephalographic (EEG) signals, electroneurographic (ENG) signals, electromyogram (EMG) signals, blood pressure signals, etc. The vital signs are measures of physiological statistics, for example, body temperature, pulse rate, blood pressure, respiratory rate, etc., of a patient that enable assessment of basic body functions of the patient. In an example, the information carrier device employs ECG/EEG monitoring sensors and associated software that analyzes electrical impulses or heartbeats of the patient's heart and tracks irregularities or disturbances from preconfigured settings. The information carrier device biometrically tracks the identity of the patient by processing the biomedical signals, for example, through pattern recognition of ECG shapes, linear predictive coding techniques, etc.

In an embodiment, the information carrier device generates an alarm notification, for example, on detecting a divergence of vital signs of the patient from preconfigured settings in the information carrier device. The preconfigured settings are, for example, in accordance with established health standards. For example, the information carrier device may set off an audio alarm, a beep sound, a vibrating alarm, a flashing light, etc., as an alarm notification when the information carrier device detects that the patient's body temperature or blood pressure diverges from preconfigured safe levels. The information carrier device also generates an alarm notification on detecting a loss of signal contact, for example, between the information carrier device and external responder devices. External responder devices comprising sensors that record patient information typically have a limited range, and if the information carrier device is dropped or is left behind and falls out of the signal range of the external responder devices, the information carrier device generates an alarm notification. In an example, the information carrier device may set off an audio alarm on determining that the information carrier device has lost signal contact with the external responder devices, possibly due to the information carrier device being dropped or left behind during transportation of the patient to a medical treatment facility. Furthermore, the information carrier device generates an alarm notification on determining a misassociation between the information carrier device and the patient. The information carrier device generates a preemptive alarm notification to alert medical personnel of a possible misplacement or an incorrect association between the information carrier device and the patient. For example, the information carrier device generates an alarm notification if the information carrier device is employed for a patient different from the patient to whom the information carrier device was originally assigned.

The method disclosed herein provides a data storage unit in the information carrier device. The data storage unit stores the patient information, a medical examination report generated by a patient information processing system, information on medical situations, and triage information in one or more of multiple individual and combined formats in the information carrier device. As used herein, the term “format” refers to a configuration of content and/or a file in which the patient information, observational data, the medical examination report, information on medical situations, triage information, etc., can be stored and rendered for observation and interpretation. The formats comprise, for example, a text format, a portable document format, an audio format, a video format, an audiovisual format, an image format, an animation format, a multimedia format, a rich content format, etc. The triage information comprises, for example, instructions for categorizing and determining priorities of patients' treatments based on severity of the patients' conditions, treatment instructions, etc. The information carrier device retains the stored information and allows extraction of the stored information without being powered by batteries. The data storage unit of the information carrier device is accessible via a user interface, for example, through an audio based access, a manual access, etc., for enabling accurate medical examination and treatment of the patient. In an example, the information carrier device can store a knowledge base of medical situations and triage instructions to aid a first responder who accesses the knowledge base of the information carrier device, for example, through an audio based access, a manual access, etc., in treating the patient, without the guidance of supervisory medical personnel. The knowledge base, for example, provides a mapping of each medical situation to a possible triage priority number that guides the medical personnel in setting the triage information for the patient accordingly.

A responder may utilize the information carrier device for obtaining triage information. As used herein, the term “responder” refers to a person at a point of first care of a patient, who performs a preliminary assessment of a condition of the patient and administers initial treatment to the patient. The responder is, for example, a certified first responder, a paramedic, first aid personnel, etc. In an example, the responder may speak a query in an audio format into a recording unit of the information carrier device or enter a query in a text format on a user interface of the information carrier device, for obtaining instructions on the treatment of the patient. The information carrier device receives the query from the responder, for example, in the audio format or the text format. The information carrier device performs data recognition on the query received from the responder for extracting keywords from the query. The information carrier device performs a search for triage information in the knowledge base using the extracted keywords and renders the triage information in one or more of multiple formats, for example, an audio format, a video format, an audiovisual format, a text format, etc., on the user interface of the information carrier device for enabling prioritized treatment of the patient.

The information carrier device allows a first responder to search the knowledge base through a voice based search or a manual topic based search through scrolling. The knowledge base is accessible, for example, via the information carrier device and/or a communication network. The first responder may submit an oral query requesting information on the steps of a treatment procedure for treating a particular injury of a patient. The information carrier device performs audio recognition on the oral query, extracts keywords from the query, performs a search for the keywords in the knowledge base, and outputs the search results comprising, for example, a triage priority number, the steps of the treatment, etc., on the user interface allowing the first responder to proceed with the treatment.

The method disclosed herein also provides a data extraction unit and the patient information processing system. The data extraction unit and the patient information processing system electronically communicate with the information carrier device, for example, by a wired mode of communication, a wireless mode of communication via a communication network, or a combination thereof. As used herein, the “communication network” is, for example, a Bluetooth® communication network, a communication network that implements Wi-Fi® of the Wireless Ethernet Compatibility Alliance, Inc., an ultra-wideband communication network (UWB), a wireless universal serial bus (USB) communication network, a ZigBee® communication network, a general packet radio service (GPRS) network, a mobile telecommunication network, a local area communication network, an internet connection network, an infrared communication network, etc. The mobile telecommunication network is, for example, a global system for mobile (GSM) communications network, a code division multiple access (CDMA) network, a third generation (3G) mobile communication network, etc. The wired mode of communication is implemented, for example, via a wired interface such as a universal serial bus (USB) interface, a universal asynchronous receiver/transmitter (UART) interface, a recommended standard 485 (RS-485) interface, a customized wired interface, etc. The data extraction unit extracts 103 the stored patient information from the information carrier device, for example, by reading the stored patient information from the information carrier device. The data extraction unit is configured, for example, as an electronic memory card reader that connects externally to the information carrier device.

The data extraction unit electronically communicates with the patient information processing system, for example, by a wired mode of communication, a wireless mode of communication via the communication network, or a combination thereof. The data extraction unit may be used for extracting the patient information from the information carrier device at all the echelons of care. For example, the data extraction unit may be used by medical personnel while operating at a war front, during transport of the patient to a medical treatment facility, at a medical treatment base, at a remote medical facility, etc. As used herein, the term “medical facility” refers to a medical establishment that provides secondary care to the patient and is, for example, a clinic, a hospital, a medical treatment facility, etc. The data extraction unit transmits 104 the extracted patient information to the patient information processing system, for example, by a wired mode of communication, a wireless mode of communication via the communication network, or a combination thereof. In an embodiment, the patient information processing system directly extracts the patient information from the information carrier device, for example, by a wired mode of communication, a wireless mode of communication via the communication network, or a combination thereof.

In an embodiment, a recording unit is provided for recording 105 observational data comprising, for example, medical examination information, information on the treatment prescribed for the patient, etc. As used herein, the term “observational data” refers to information provided by medical personnel on carrying out a medical examination of the patient. Observational data comprises, for example, the steps of the treatment administered to the patient, general observations on the medical condition of the patient such as a location of an injury, recorded symptoms of the patient, etc. The recording unit is, for example, an audio or voice recorder, a video recorder, a text content recorder, an image capture device, a multimedia recorder, or any combination thereof. The recorded observational data comprises, for example, one or more of audio content, video content, text content, audiovisual content, image content, multimedia content, and any combination thereof. In an embodiment, a wired or wireless microphone or a headset with a microphone is provided for enabling medical personnel to record and vocally provide medical information and observations into the recording unit as the medical personnel treat the patient. The recorded observational data may be stored, for example, as digital data files in the recording unit. The observational data can be used by medical personnel to update electronic medical records of the patient subsequent to a medical treatment. For example, in a wartime scenario, the patient information and the recorded observational data is used to fill an electronic medical form such as a United States (US) Field Medical Card Form, Department of Defense (DD) 1380. In an embodiment, the recording unit and/or the patient information processing system recognize and transform one or more of the audio content, the video content, the text content, the audiovisual content, the image content, the multimedia content, or any combination thereof, from the recorded observational data into one or more of multiple content formats, for example, a text content format, an audio content format, a video content format, an audiovisual content format, an image content format, a multimedia content format, etc.

In an embodiment, the recording unit provisioned in the information carrier device enables updation of the patient information in the information carrier device continuously or at predetermined time intervals during the transport of the patient to a remote medical facility. In another embodiment, the patient information processing system extracts the recorded observational data from the recording unit and transmits the recorded observational data to the information carrier device continuously or at predetermined time intervals, for example, via a wired mode of communication, a wireless mode of communication via the communication network, or a combination thereof, for updating the patient information in the information carrier device. For example, the patient information processing system automatically extracts information that qualifies as patient information from the recorded observational data, for example, an oral description of the patient's medical condition as spoken by the medical personnel, and updates the patient information in the information carrier device. Medical personnel attending to the patient may update the patient information in the information carrier device continuously or at predetermined time intervals, during the transport of the patient to the remote medical facility.

In an embodiment, the recording unit is configured to establish bidirectional remote communication with a remote medical facility to transmit the recorded observational data to the remote medical facility and receive instructions from the remote medical facility to determine, for example, triage information for the patient. For example, a first responder examining the patient at the site of the injury of the patient can record the observational data on the patient using the recording unit and make a request for triage instructions. The recording unit is configured to establish bidirectional remote communication with a remote medical facility via a wireless link, for example, via a mobile communication network such as the global system for mobile (GSM) communications network. The recording unit transmits the recorded observational data in one or more of the formats to the remote medical facility via the wireless link. Medical personnel who are supervising the condition of the patient from the remote medical facility can analyze the recorded observational data and decide on the treatment to be administered to the patient. Further, the medical personnel can provide a mapping between a particular injury and the urgency with which the treatment must be provided to the patient. That is, the medical personnel can provide instructions to allow the first responder to determine the triage information for the patient. The recording unit utilized by the first responder receives the instructions for determining the triage information for the patient from the remote medical facility, via the wireless link. The instructions may be in the form of audio or video information. The first responder can determine the steps of the treatment and the triage information, for example, a triage priority number that specifies the priority order in which the patient must be treated, from the received instructions. The first responder determines the triage information and stores the triage information in the information carrier device.

In an embodiment, the recording unit performs echo cancellation, audio compression and decompression, image compression and decompression, video compression and decompression, etc., of the recorded observational data for establishing the bidirectional remote communication between the recording unit and the remote medical facility. For example, the recording unit associated with the information carrier device of the patient performs echo cancellation using adaptive algorithms such as a least mean square (LMS) adaptive algorithm, a recursive least square (RLS) algorithm, etc., to remove echo from the audio content of the observational data for establishing bidirectional or two-way communication between the recording unit and the remote medical facility.

The recording unit performs audio and/or video compression/decompression of the recorded observational data for expediting transmission or reception of the recorded observational data between the recording unit and the remote medical facility. For example, the recording unit employs standard audio compression algorithms and audio compression file formats such as the moving picture experts group—1 (MPEG1) audio encoding format, the moving picture experts group—2 (MPEG2) audio encoding format, etc., image compression algorithms and file formats such as a joint photographic experts group (JPEG) format, a tagged image file format (TIFF), etc., video compression algorithms and video compression file formats such as moving pictures experts group (MPEG) video encoding format, the moving picture experts group—2 (MPEG2) video encoding format, a motion joint photographic experts group (M-JPEG) video format, etc., to expedite the transmission of bulky audio and video files that have captured the recorded audio and video observational data to a remote medical facility, the reception of medical instructions from the remote medical facility, etc. The recording unit enables simultaneous transmission and reception of observational data between the medical personnel attending to the patient at the site of the injury, and medical personnel supervising the condition of the patient from the remote medical facility, thereby establishing a continuous data flow.

In an embodiment, the recording unit automatically appends additional data items to the recorded observational data for notifying the medical examination information, diagnostic information, treatment information, etc., to medical personnel at the next echelon of care. The additional data items are collected, for example, as header information that is appended to each of the digital data files comprising the recorded observational data. The additional data items also facilitate file management of the digital data files in a medical information database of the patient information processing system that stores the patients' records. In an embodiment, the recording unit automatically appends time stamps to the recorded observational data such that the exact date and time of each diagnosis and treatment of a patient by medical personnel is recorded and stored along with the observational data, and can be retrieved by medical personnel through the echelons of care. In an embodiment, a speech synthesizer associated with the recording unit converts the appended timestamps to an audio format, for example, speech data to enable audio playback of the appended timestamps along with the recorded observational data. For example, the speech synthesizer synthesizes a time stamp recorded in a text format to a speech format and enables the recording unit to play back the timestamp in the speech format along with the recorded observational data.

In an embodiment, the recording unit or the patient information processing system synchronizes different forms of observational data, for example, audio content, image content, etc., based on the timestamps appended to the observational data. This allows a responder to determine the times of treatment administered to the patient to ensure that the patient, for example, is not overdosed and also allows successful treatment protocols to be identified with the relevant diagnosis, dosage information, and information on the time of diagnosis and administration of treatment to the patient. In another embodiment, the recording unit further adds a recorder identification number to the recorded observational data to identify a specific recording unit that has recorded the observational data. The recorder identification number is, for example, a serial number printed on a microphone.

In an embodiment, the recording unit is a standalone unit that communicates with the patient information processing system. The recording unit electronically communicates with the patient information processing system, for example, by a wired mode of communication, a wireless mode of communication via the communication network, or a combination thereof. In another embodiment, the recording unit is integrated in the patient information processing system for recording and playback of the observational data. In another embodiment, the information carrier device is provisioned with the recording unit and one or more interface elements. The interface elements on the information carrier device enable activation of the recording unit for recording and playback of the observational data. The patient information processing system operated by the medical personnel extracts 106 the recorded observational data from the recording unit, for example, by a wired mode of communication, a wireless mode of communication via the communication network, or a combination thereof.

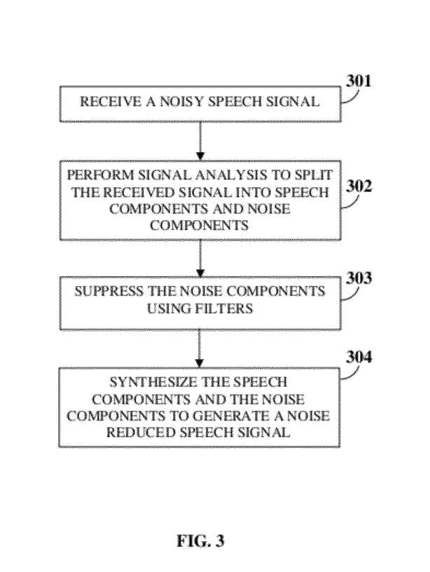

The patient information processing system, in electronic communication with the data extraction unit and the recording unit, receives and manages the patient information and the extracted observational data. In an embodiment, the electronic communication between the data extraction unit and the patient information processing system is a wired connection. In another embodiment, the electronic communication between the data extraction unit and the patient information processing system is a wireless connection supported, for example, by a transceiver supporting wireless technology standards such as Bluetooth®, Wi-Fi® of the Wireless Ethernet Compatibility Alliance, Inc., etc. Furthermore, a standalone recording unit communicates with the patient information processing system, for example, by a wired connection or a wireless link. In an embodiment, the recording unit improves signal-to-noise ratio and suppresses background noise of the recorded observational data prior to extraction of the recorded observational data from the recoding unit by the patient information processing system as disclosed in the detailed description of FIG. 3.

The patient information processing system processes and analyzes 107 the patient information received from the information carrier device and/or the data extraction unit, and the recorded observational data extracted from the recording unit. The patient information processing system enables the medical personnel to access and manage the patient information and the observational data. The medical personnel can analyze the patient information via the patient information processing system to obtain the prior medical history of the patient. The patient information processing system is, for example, a handheld patient information processing system, a mobile phone, a laptop, a personal digital assistant, a tablet computer, a handheld audio recording device, a personal computer, etc., operated by the medical personnel. The patient information processing system is operated, for example, by medical personnel at a war front, at a remote medical facility, at a medical treatment base, during transport of the patient to a medical treatment facility, etc.

In an embodiment, the processing and the analysis of the extracted observational data performed by the patient information processing system comprises improving signal-to-noise ratio and suppressing background noise of the observational data as disclosed in the detailed description of FIG. 3. In an embodiment, the improvement of the signal-to-noise ratio of the recorded observational data and suppression of background noise is performed as disclosed in co-pending patent application number 13/049,877 titled “Microphone Array System” filed on Mar. 16, 2011 in the United States Patent and Trademark Office. For example, the recording unit in the patient information processing system employs a built-in N microphone array system comprising an array of sound sensors positioned in an arbitrary configuration for receiving the observational data, an adaptive beamforming unit, and a noise reduction module for enhancing the signal-to-noise ratio of the recorded observational data and for suppressing the background noise signals. The adaptive beamforming unit performs adaptive beamforming for steering a directivity pattern of the array of sound sensors in a direction of a spatial location of a target sound signal from a target sound source that provides the observational data. Further, the adaptive beamforming unit employs adaptive filters that adaptively filter the background noise signals in response to detecting the presence or absence of the target sound signal in the signals received from disparate signal sources. The noise reduction module suppresses the background noise signals for further enhancing the target sound signal from the target sound source that provides the observational data. The improvement of the signal-to-noise ratio and the suppression of the background noise of the recorded observational data may also be performed in a standalone recording unit prior to transmission of the recorded observational data to the patient information processing system.

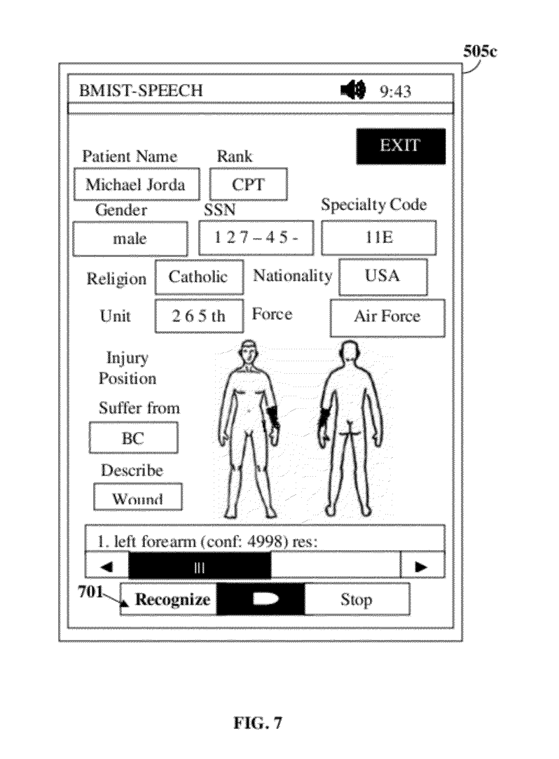

The patient information processing system generates 108 a medical examination report in one or more of multiple individual and combined formats, for example, a text format, a portable document format, an audio format, a video format, an audiovisual format, an image format, a multimedia format, etc., based on the processing and the analysis of the patient information received from the information carrier device and/or the data extraction unit, and the recorded observational data extracted from the recording unit. A screenshot of a user interface rendering a medical examination report generated by the patient information processing system is exemplarily illustrated in FIG. 7. In an embodiment, the patient information processing system utilizes the patient information received from the information carrier device and/or the data extraction unit and the observational data extracted from the recording unit to automatically fill out an electronic medical form such as the United States (US) Field Medical Card Form, for example, Department of Defense (DD) Form 1380, and transmit the filled out electronic medical form to concerned authorities via the communication network. The patient information processing system automatically fills up predefined forms or generates records and summaries in one or more formats by automatically summarizing the transmitted patient information and the recorded observational data in different formats. In an embodiment, the patient information processing system generates the medical examination report by extracting keywords from the transmitted patient information and/or the recorded observational data and automatically populates the medical examination report. Furthermore, the patient information processing system allows a particular relevant section of the recorded observational data to be extracted by providing specific keywords. The patient information processing system extracts the relevant information on the basis of the keywords and automatically completes the required medical forms and documentation necessary for a patient. Doctors, patients, insurance companies, medical treatment facilities, etc., can therefore obtain completed medical forms, medical insurance documents, etc., via the patient information processing system.

In an embodiment, the patient information processing system selectively extracts information on health conditions and the treatment administered to the patient from each recording of the observational data for generating a health record for each recording of the observational data. In an example, the recording unit performs audio recognition on audio content of the recorded observational data and selectively extracts only the information on a health condition and treatment administered to the patient. The health record comprises selective information on the health condition and the treatment administered to the patient. Each health record serves as an independent record of a particular health condition or ailment of the patient and the treatment provided for the health condition. The generation of separate health records enables specialized medical personnel to look at individual ailments and injuries and provide treatment to the patient accordingly.

In an embodiment, the patient information processing system integrates the selectively extracted information across multiple recordings of the observational data of the patient for ensuring that implicit information recorded on the health conditions and the treatment administered to the patient in one or more recordings of the observational data is explicitly recorded in each generated health record. In an example, a patient may have been found to be allergic to a particular drug, for example, penicillin, necessitating an alternative drug to be administered to the patient. This implicit information is explicitly recorded in each of the health records. Since the patient may be treated by different medical personnel at each echelon of care, the medical personnel are aided by the explicit specification of the patient's health condition in each health record. In another example, a medicine administered to a patient as part of the treatment for a particular injury or ailment may be recorded in a first recording of the observational data. The medicine may be effective for other ailments as well. The patient information processing system merges the selectively extracted information specifying that the medicine has been administered to the patient, thereby averting the possibility of repeated administration of the same medicine to the patient.

In an embodiment, the patient information processing system extracts keywords from the recorded observational data, tags the extracted keywords to the generated health record associated with the recorded observational data, and stores the generated health record and the recorded observational data, for example, in a medical information database of the patient information processing system, and the data storage unit of the information carrier device for enabling an expedited retrieval of the generated health record and the recorded observational data using the keywords. For example, the patient information processing system may perform an audio recognition of the recorded observational data and extract keywords from the recorded observational data. The patient information processing system stores a copy of the health record in the information carrier device. In an example, the stored health records of the patient may be tagged with appropriate keywords extracted or recognized from the recorded observational data and stored along with the observational data. This enables a faster search and retrieval of the health records of the patient based on the keywords. Further, this allows the medical personnel to perform a quick search for a particular health record or a record of observational data comprising, for example, an audio content file, using on only a keyword instead of performing a thorough search through the medical information database that stores the audio content files.

In an embodiment, the medical information database of the patient information processing system collates multiple health records of multiple patients stored in the medical information database based on the extracted keywords for tracking injuries of the patients and medical reactions to the treatment and medicines administered to the patients, recording instances of particular injuries for tracking and research, etc. For example, the medical information database collects all health records tagged with a keyword specifying the use of a particular drug. The health records collected may be from different patients allowing the medical personnel, for example, to analyze the side effects of the drug, the effectiveness of the drug in treating a particular type of injury, etc.

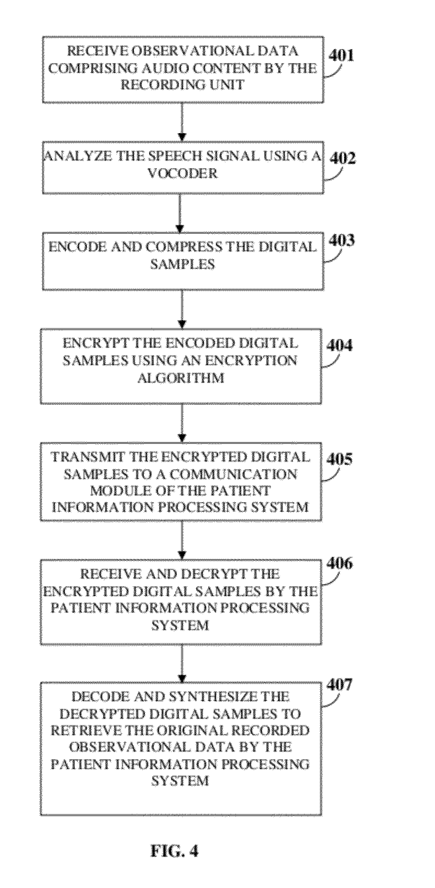

In an embodiment, the patient information and the generated medical examination report are secured in the information carrier device, the data extraction unit, and the patient information processing system, for example, using an encryption mechanism. A method for securing recorded observational data comprising audio content for enabling a secure transmission of the recorded observational data to the patient information processing system over a communication network is disclosed in the detailed description of FIG. 4. The observational data are converted into digital samples, which are encrypted, for example, by the information carrier device and decrypted by the patient information processing system. The patient information processing system employs cryptographic algorithms compliant with the health information privacy requirements of the health insurance portability and accountability act (HIPAA). For example, the patient information processing system employs cryptographic algorithms, for example, the advanced encryption standard (AES), elliptic curve cryptography (ECC), rivest cipher 5 (RC5) cryptography, rivest shamir adleman cryptography (RSA), etc., for encrypting and/or decrypting image content, video content, etc.

The patient information processing system transmits 109 the generated medical examination report in one or more of the formats to the information carrier device for updating the patient information in the information carrier device, for example, by a wired mode of communication, a wireless mode of communication via the communication network, or a combination thereof. The generated medical examination report enables the medical personnel attending the patient to perform an accurate medical examination and treatment of the patient. In an embodiment, the patient information processing system also transmits the generated medical examination report to a remote medical facility in one or more of the formats via the communication network for updating the patient information at the remote medical facility for ensuring quick treatment based on the medical history of the patient, when the patient is transferred to the remote medical facility for subsequent treatment. In another embodiment, a remote medical facility directly extracts the updated patient information from the information carrier device, for example, via a wired interface, a communication network, or by using the data extraction unit for updating the patient information at the remote medical facility. The generation of the medical examination report in one or more of multiple formats and the updation of the patient information in the information carrier device enable the documentation and management of the patient information in real time for accurate medical examination and the treatment of the patient.

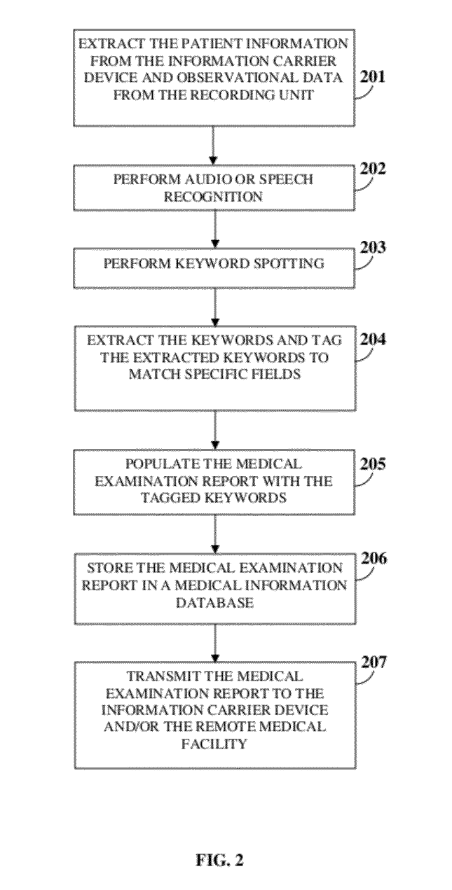

FIG. 2 exemplarily illustrates a method for processing and analyzing patient information and recorded observational data performed by the patient information processing system. The patient information processing system extracts 201 the patient information from the information carrier device directly or via the data extraction unit, and the observational data from the recording unit. For example, the patient information processing system extracts the patient information from the information carrier device and observational data spoken by medical personnel into the recording unit associated with the patient information processing system. The patient information processing system performs 202 audio or speech recognition of the observational data containing audio content, for example, speech data. For example, the patient information processing system converts the recorded observational data comprising the audio content to text content. The patient information processing system performs 203 keyword spotting, for example, by scanning through the text content and determining keywords, for example, important medical terms, and patient information in the text content.

In an embodiment, the patient information processing system identifies keywords pertaining to predefined medical terms directly in the audio content from the recorded utterances of the medical personnel. The patient information processing system compares the speech segments extracted from the audio content with keywords extracted from the medical information database to identify the relevant keywords.

Consider an example where the medical personnel utter the patient's injury as “Avulsion fracture” into the recording unit. The recording unit records the utterance for extraction by the patient information processing system. The patient information processing system converts the utterance to text and performs a search for the keyword “Avulsion fracture” in the medical information database. In an embodiment, the patient information processing system determines an index to which the keyword is assigned, and, using the index, determines that the keyword describes the nature of the injury sustained by the patient. The patient information processing system extracts 204 the keywords and tags the keywords to match a specified field, for example, “nature of injury” for generation of the medical examination report. The patient information processing system populates 205 the medical examination report, for example, a medical form with the tagged keywords. The patient information processing system stores 206 the medical examination report in the medical information database. The patient information processing system then transmits 207 the medical examination report to the information carrier device and/or the remote medical facility.

FIG. 3 exemplarily illustrates a method for improving signal-to-noise ratio and suppressing background noise of recorded observational data. Consider an example where the recording unit associated with the patient processing system receives 301 noisy observational data, for example, a noisy speech signal as an input. The recording unit performs 302 signal analysis to split the received signal into speech components and noise components, where the speech components comprise the observational data, and the noise components comprise background noise. The recording unit applies, for example, a Fourier transformation to split the received signal into its constituent frequency components. In an embodiment, the method disclosed herein employs a non-uniform filter bank, for example, a Wiener filter, for splitting the noisy speech signal into speech components and noise components.

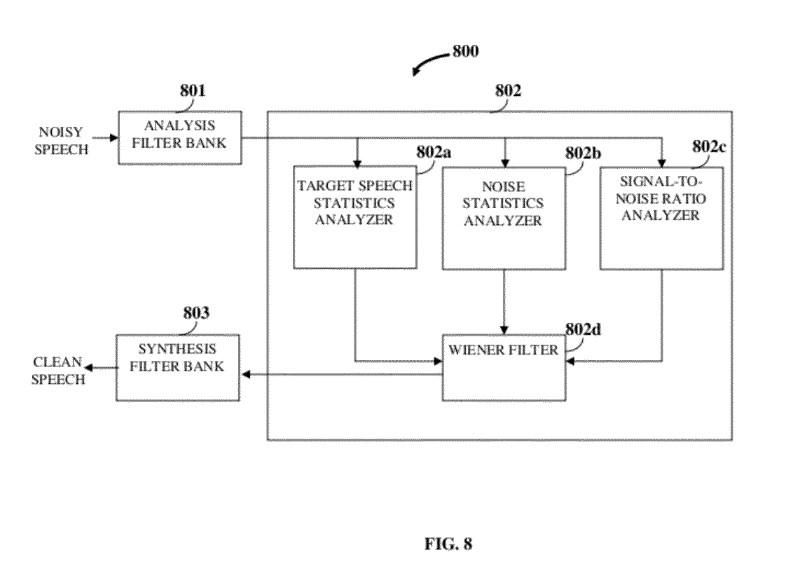

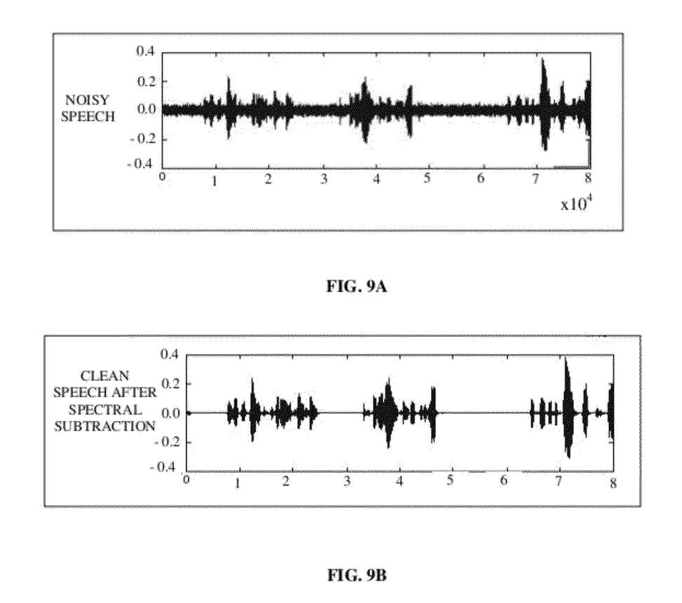

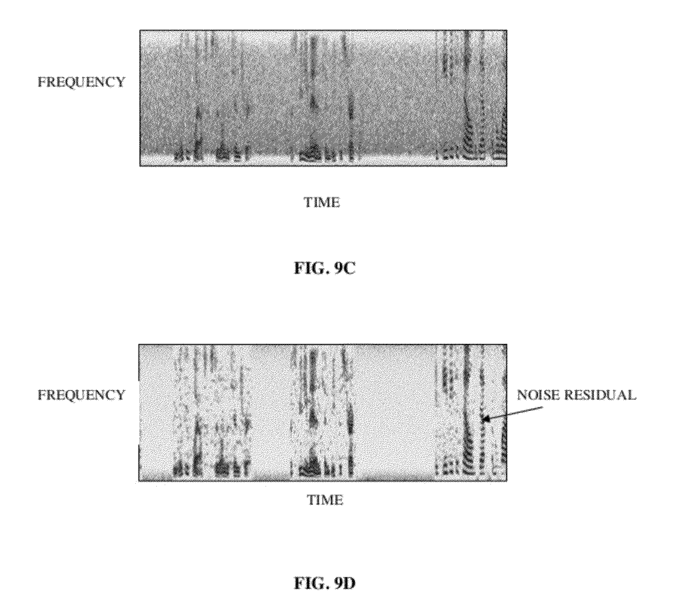

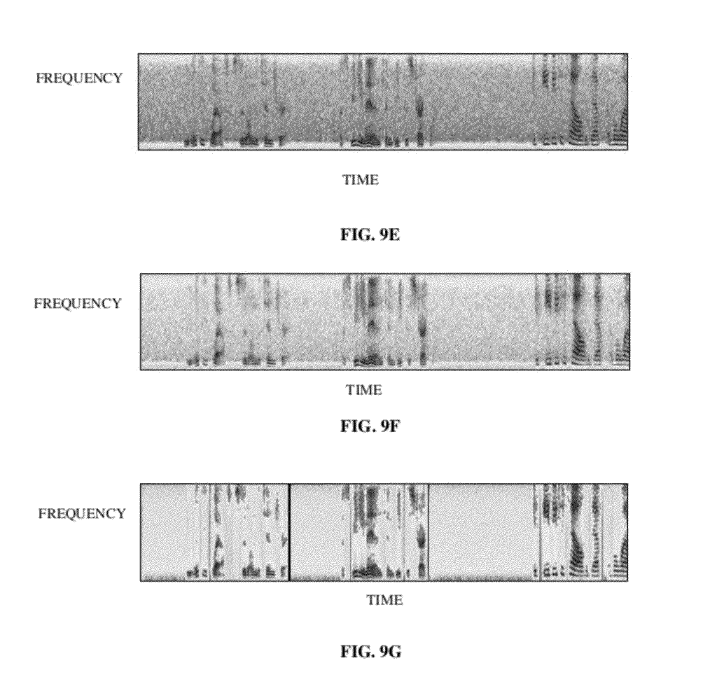

The recording unit suppresses 303 the noise components using filters configured to operate in accordance with noise cancellation algorithms as disclosed in the detailed description of FIG. 8, FIGS. 9A-9G, FIGS. 10A-10B, and FIGS. 11A-11B. The recording unit synthesizes 304 the speech components and the noise components to generate a noise reduced speech signal. The noise reduced speech signal comprises relevant audio content of the recorded observational data.

FIG. 4 exemplarily illustrates a method for securing recorded observational data comprising audio content for enabling a secure transmission of the recorded observational data to the patient information processing system over a communication network. Consider an example where the information carrier device worn by a patient is provisioned with the recording unit. Medical personnel may therefore record their observations using the recording unit in the information carrier device. The recording unit receives 401 observational data comprising audio content in the form of a speech signal from the medical personnel. In an embodiment, the recording unit employs, for example, a vocoder to analyze 402 the speech signal, abstract specific parameters such as pitch, spectral energy content, etc., from the speech signal, and generate digital samples representing the parameters of the speech signal. The recording unit encodes 403 the digital samples and compresses 403 the encoded digital samples, for example, using a mixed excitation linear prediction speech coding standard (MELPe).

The information carrier device encrypts 404 the encoded digital samples with an encryption key using an encryption algorithm, for example, the advanced encryption standard (AES) algorithm. The information carrier device transmits 405 the encrypted digital samples over the communication network to a communication module of the patient information processing system comprising, for example, a transceiver. The communication module of the patient information processing system receives the encrypted digital samples and decrypts 406 the encrypted digital samples using a decryption key known to the patient information processing system. Further, the patient information processing system decodes and synthesizes 407 the decrypted digital samples to retrieve the original recorded observational data.

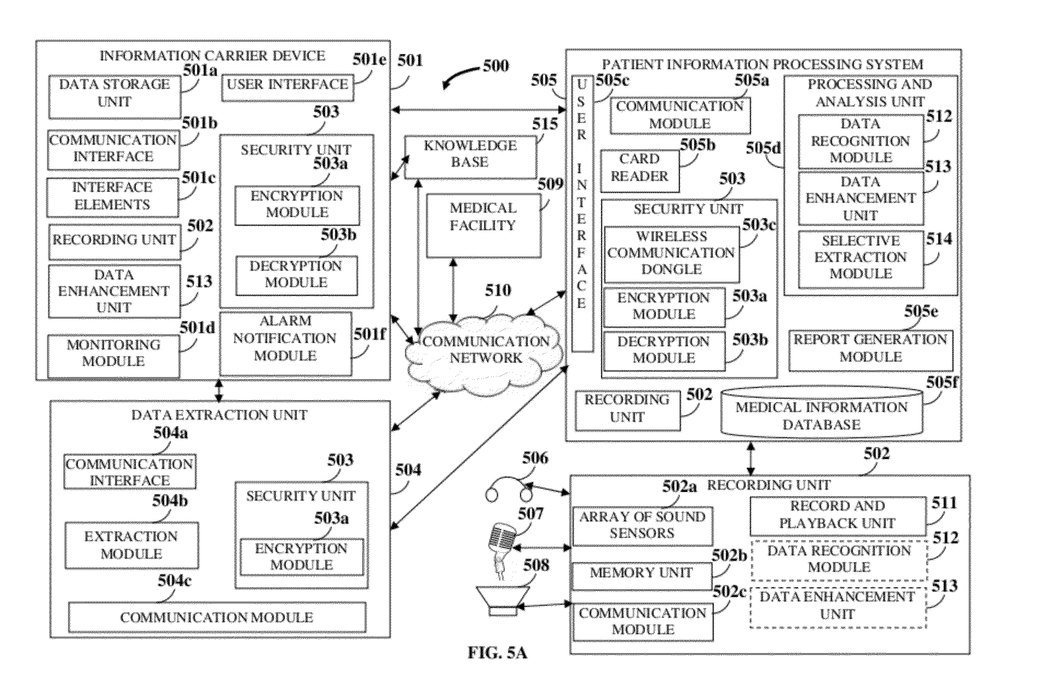

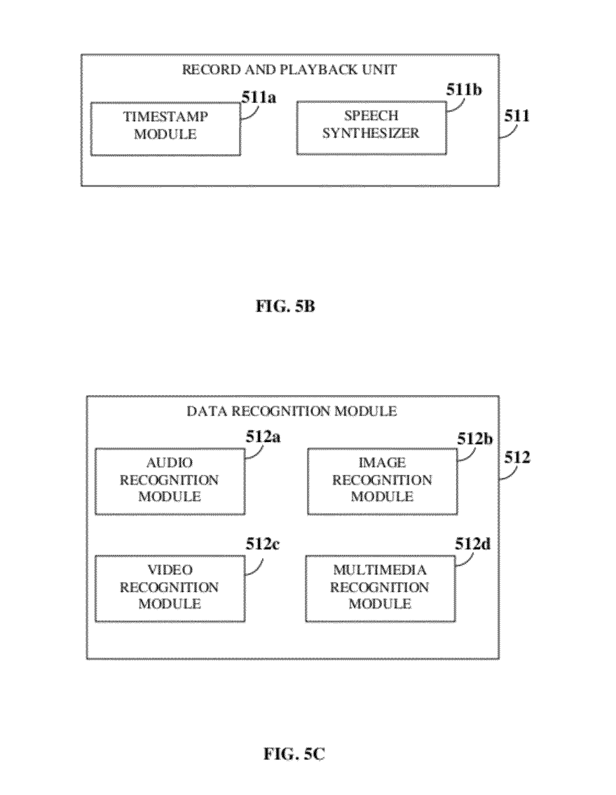

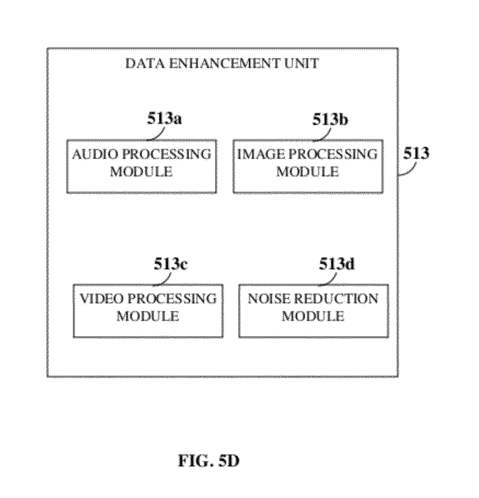

FIGS. 5A-5D exemplarily illustrate a system 500 for documenting and managing patient information in real time for accurate medical examination and treatment of a patient. As exemplarily illustrated in FIG. 5A, the system 500 disclosed herein comprises an information carrier device 501, a data extraction unit 504, a recording unit 502, and a patient information processing system 505. The data extraction unit 504 and the patient information processing system 505 electronically communicate with the information carrier device 501, for example, by a wired mode of communication, a wireless mode of communication via a communication network 510, or any combination thereof. For example, the information carrier device 501 electronically communicates with the data extraction unit 504 via their respective communication interfaces 501b and 504a. Each of the communication interfaces 501b and 504a is, for example, a wired interface such as a universal serial bus (USB) interface, a universal asynchronous receiver/transmitter (UART) interface, a recommended standard 485 (RS-485) interface, a customized wired interface, etc. In another example, the information carrier device 501 electronically communicates with the data extraction unit 504 via respective wireless interfaces that use a wireless protocol, for example, the Bluetooth® communication protocol.

The patient information processing system 505 also electronically communicates with the information carrier device 501 via the communication network 510, for example, a communication network that implements Wi-Fi® of the Wireless Ethernet Compatibility Alliance, Inc., a general packet radio service (GPRS) network, a mobile telecommunication network, a local area communication network, an internet connection network, a Bluetooth® communication network, an infrared communication network, etc. In an embodiment, the information carrier device 501 directly communicates with the patient information processing system 505 for enabling the patient information processing system 505 to extract the patient information. In another embodiment, the patient information processing system 505 extracts the patient information from the information carrier device 501 via the data extraction unit 504. In an embodiment, there is no wireless signal transmission from the information carrier device 501. This ensures that the location and identity of the patient is concealed, thereby ensuring safety of the patient. For example, a soldier wearing the information carrier device 501 cannot be detected by an enemy, since there is no wireless signal transmission from the information carrier device 501.

The information carrier device 501 comprises a data storage unit 501a and a communication interface 501b. The data storage unit 501a is, for example, an electronic memory card, a secure digital (SD) memory card, a flash drive, and any other type of non volatile electronic memory device. The data storage unit 501a stores the patient information, for example, the patient's medical records, identification information, biometric information, personal information, the patient's medical examination report, information on medical situations, triage information, etc., in one or more of multiple formats, for example, a text format, a portable document format, an audio format, a video format, an audiovisual format, an image format, an animation format, a multimedia format, a rich content format, etc., for enabling medical personnel to perform accurate medical examination and treatment of the patient in emergency situations.

In an embodiment, the system 500 disclosed herein further comprises a knowledge base 515 accessible via the data storage unit 501a of the information carrier device 501 and/or via the communication network 510. That is, the knowledge base 515 can be accessed locally on the information carrier device 501 and/or via a wireless mode of communication via the communication network 510. The knowledge base 515 stores information on medical situations and triage information in one or more of the formats, for example, a text format, an audio format, a video format, an audiovisual format, an image format, a multimedia format, etc., accessible through an audio based access and/or a manual access for enabling the accurate medical examination and the treatment of the patient.

In an example, the system 500 disclosed herein provisions the data storage unit 501a of the information carrier device 501 with the knowledge base 515 comprising a compilation of medical situations and triage information. The data storage unit 501a is accessible via a user interface 501e through an audio based access, a manual access, etc., for enabling accurate medical examination and treatment of the patient. For example, the information carrier device 501 in association with the recording unit 502 provides options to the user to access the knowledge base 515 through the user interface 501e of the information carrier device 501 for performing an audio based search as disclosed in the detailed description of FIG. 1. The information carrier device 501 also allows medical personnel to perform a manual topic based search through the user interface 501e as disclosed in the detailed description of FIG. 1. The information carrier device 501 is waterproof, dust-proof, and power independent. That is, the information carrier device 501 does not require power to hold the patient information. Moreover, the information carrier device 501 is portable, lightweight, and inexpensive, and can therefore be assigned to a large number of individuals in emergency situations. For example, in a wartime environment, the information carrier device 501 can be assigned to each of the soldiers fighting the war.

The data storage unit 501a of the information carrier device 501 stores the patient information in an electronic form and arranges the patient information in a format that allows quick access of the stored patient information. The data storage unit 501a has sufficient memory capacity, for example, about 2 gigabytes (GB) to about 32 GB, to store the patient information. The data storage unit 501a has, for example, the memory capacity of typical non-volatile memory cards such as a micro secure digital (SD) card.

In an embodiment, the data storage unit 501a of the information carrier device 501 is a standalone unit and is capable of interfacing directly with both the information carrier device 501 and with the patient information processing system 505. In an embodiment, the data storage unit 501a is a memory card that is carried separately by a patient, for example, a soldier, as a tag. The data storage unit 501a configured as a memory card plugs into each of the information carrier device 501 and the patient information processing system 505 by inserting the memory card in a memory card drive associated with the information carrier device 501 and the patient information processing system 505 respectively.

The communication interface 501b of the information carrier device 501 facilitates a wired and/or a wireless connection between the information carrier device 501 and the data extraction unit 504. The communication interface 501b of the information carrier device 501 is, for example, a wired interface that facilitates electronic communication between the information carrier device 501 and the data extraction unit 504. In an example, the wired interface comprises a universal serial bus (USB) data port and/or a connecting data jack that enables extraction of the patient information by providing a physical wired path for data transfer between the information carrier device 501 and the data extraction unit 504. The communication interface 501b of the information carrier device 501 comprises, for example, a universal serial bus (USB) port that connects from the USB port on the information carrier device 501 to a USB jack on the data extraction unit 504. In another example, the communication interface 501b comprises, for example, a universal serial bus (USB) jack that connects from the USB jack on the information carrier device 501 to a USB port on the data extraction unit 504.

The communication interface 501b of the information carrier device 501 interfaces with the data extraction unit 504, the patient information processing system 505, external responder devices, remote medical facilities, etc., that extract the patient information from the information carrier device 501. The communication interface 501b of the information carrier device 501 enables communication of the patient information, the recorded observational data, biomedical signals, etc., to the data extraction unit 504 and the patient information processing system 505. The data extraction unit 504 allows the information carrier device 501 to be wireless interface agnostic and compatible with multiple wireless networks. Although the detailed description refers to USB communication interfaces, the scope of the communication interfaces 501b and 504a of the information carrier device 501 and the data extraction unit 504 respectively are not limited to USB communication interfaces but may be extended to include other forms of wired and wireless communication interfaces supported by multiple wired and/or wireless communication protocols.

In an embodiment, the information carrier device 501 further comprises a monitoring module 501d and an alarm notification module 501f. The monitoring module 501d monitors biomedical signals of the patient for verifying vital signs of the patient and biometrically tracks the identity of the patient as disclosed in the detailed description of FIG. 1. The alarm notification module 501f generates an alarm notification, for example, on detecting a divergence of the vital signs of the patient from preconfigured settings in the information carrier device 501, on detecting a loss of signal contact between the information carrier device 501 and external responder devices, on detecting a misassociation between the information carrier device 501 and the patient, etc., as disclosed in the detailed description of FIG. 1.

In an embodiment, the information carrier device 501 further comprises a security unit 503 for securing and ensuring privacy of the patient information and the medical examination report. The security unit 503 comprises an encryption module 503a for encrypting the patient information and a decryption module 503b for decrypting, for example, the medical examination report generated and transmitted by the patient information processing system 505. In an embodiment, the information carrier device 501 further comprises a recording unit 502 with a headset 506 and a microphone 507 for enabling medical personnel to directly record the patient's observational data and play back the directly recorded observational data of the patient. In this embodiment, the information carrier device 501 further comprises one or more interface elements 501c, for example, buttons for activating the recording unit 502 for recording and playback of the observational data.

In the embodiment where the recording unit 502 is provisioned in the information carrier device 501, the information carrier device 501 further comprises a data enhancement unit 513 as exemplarily illustrated in FIG. 5D for improving signal-to-noise ratio of the recorded observational data and for suppressing the background noise of the recorded observational data. The encryption module 503a and the decryption module 503b of the security unit 503 in the information carrier device 501 perform encryption and decryption of the patient information respectively, by employing cryptographic algorithms, for example, the advanced encryption standard (AES) algorithm. In an embodiment, the encryption module 503a and the decryption module 503b of the security unit 503 in the information carrier device 501 perform encryption and decryption of the observational data comprising audio content recorded by the medical personnel, respectively as disclosed in the detailed description of FIG. 4.

The data extraction unit 504 is in electronic communication with the information carrier device 501 and the patient information processing system 505. The data extraction unit 504 is configured as a communication sled. The data extraction unit 504 comprises a communication interface 504a, an extraction module 504b, and a communication module 504c. The extraction module 504b extracts the stored patient information from the information carrier device 501 via the communication interface 504a. In an embodiment, the extraction module 504b extracts the observational data recorded by the recording unit 502 in the information carrier device 501 via the communication interface 504a. The communication interface 504a of the data extraction unit 504 physically connects to the communication interface 501b of the information carrier device 501 for extracting the stored patient information and/or the recorded observational data from the information carrier device 501. The communication interface 501b of the information carrier device 501 and the communication interface 504a of the data extraction unit 504 comprise, for example, a mutually connecting data jack and port. The mutually connecting data jack and port adheres, for example, to the USB standard or to a proprietary standard. In an example, the information carrier device 501 slides into the data extraction unit 504 through an opening in the data extraction unit 504 for interfacing with the data extraction unit 504.

In an embodiment, the data extraction unit 504 is equipped with a built-in power supply unit that provides adequate power for establishing wireless communication between the data extraction unit 504 and the patient information processing system 505, that is, by powering the communication interface 504a and the communication module 504c. For example, the patient information is extracted from the information carrier device 501 by the data extraction unit 504 via the communication interface 504a that is powered by the built-in power supply unit. The built-in power supply unit supplies power to the communication module 504c of the data extraction unit 504, comprising, for example, a transceiver to enable the transceiver to transmit the patient information to the patient information processing system 505.

In an embodiment, the data extraction unit 504 further comprises a security unit 503 for securing and ensuring privacy of the extracted patient information. The security unit 503 of the data extraction unit 504 comprises an encryption module 503a. The encryption module 503a encrypts the patient information and/or the recorded observational data received from the information carrier device 501. The data extraction unit 504 transmits the encrypted patient information and/or the recorded observational data to the patient information processing system 505, for example, via a transceiver of the communication module 504c. The patient information processing system 505 then decrypts the encrypted patient information and/or the recorded observational data prior to processing and analysis using the decryption module 503b of the security unit 503 of the patient information processing system 505.

The data extraction unit 504 electronically communicates with the patient information processing system 505, for example, by a wired mode of communication, a wireless mode of communication via the communication network 510, or a combination thereof. The communication module 504c of the data extraction unit 504, comprising, for example, a transceiver transmits the extracted patient information and/or the recorded observational data to the patient information processing system 505, for example, by a wired mode of communication, a wireless mode of communication via the communication network 510, or any combination thereof. For example, the transceiver of the data extraction unit 504 transmits the extracted patient information to the patient information processing system 505 over a wireless link such as a Bluetooth® link, a Wi-Fi® link, etc. In an example, the transceiver of the data extraction unit 504 is a wireless Bluetooth® transceiver that establishes a wireless link with the patient information processing system 505. In another example, the data extraction unit 504 transmits the extracted patient information over a wired interface that connects physically to the patient information processing system 505. The wired interface is, for example, a USB cable connecting the USB port provided on the data extraction unit 504 to the USB jack on the patient information processing system 505. A single data extraction unit 504 is shareable and reusable across multiple information carrier devices 501. Therefore, the information carrier device 501 may be assigned one per patient while the data extraction unit 504 may be shared among patients.

The recording unit 502 comprises a record and playback unit 511 for recording and playing back observational data comprising, for example, medical examination information and information on the treatment prescribed for the patient by medical personnel. In an embodiment, the recording unit 502 is an external standalone unit used by the medical personnel to record their observations while attending to a patient. The medical personnel uses a wired or wireless microphone 507 or a headset 506 with a microphone 507 to record and vocally provide medical information and observations onto the recording unit 502, while treating the patient. The recording unit 502 has voice recording and wireless communication capability. The recording unit 502 comprises, for example, commercial off-the-shelf (COTS) handheld computer hardware. The recording unit 502 is, for example, an audio or voice recorder, a video recorder, text content recorder, an image capture device, a multimedia recorder, or any combination thereof.

Medical personnel input the observational data into the recording unit 502, for example, as audio content, video content, text content, audiovisual content, image content, multimedia content, or any combination thereof. The recorded observational data is stored in a memory unit 502b of the recording unit 502. The recording unit 502 is in a wired connection or in a wireless connection with the patient information processing system 505. In an embodiment, the recording unit 502 is an image capture device, for example, a digital camera that captures images and videos of the patient or injuries of the patient. The image capture device is then connected to the patient information processing system 505 through a wired interface, for example, a USB cable, for transmitting the captured images to the patient information processing system 505 for processing and analysis. In another example, the image capture device is connected to the patient information processing system 505 via a wireless interface that supports, for example, the Wi-Fi® standard, for transmitting the captured images to the patient information processing system 505 for processing and analysis.

In another embodiment, the recording unit 502 is an audio recorder that records audio content when medical personnel vocally recite the observational data of the patient and observations on the condition of the patient into the recording unit 502. In another embodiment, the recording unit 502 is a video recorder that records video content of observations on the medical condition of the patient. In another embodiment, the recording unit 502 is a text content recorder that records text content entered by medical personnel using a keypad provided on the recording unit 502. In another embodiment, the recording unit 502 is a multimedia content recorder that records the observational data as a combination of audio content, video content, image content, and text content.

The recording unit 502 configured as an audio recorder records observational data comprising audio content. The audio recorder is a recorder that captures an audio signal, for example, the voice of a responder or voices of medical personnel, and converts the audio signal into a digital data format. The audio recorder comprises a microphone unit that captures the voice of the medical personnel, when the responders or the medical personnel orally recite the observational data. The microphone unit comprises, for example, a microphone 507, a lapel, a headset 506 with a microphone 507, a microphone 507 built into the patient information processing system 505 of the medical personnel, a radio microphone 507, etc.

The recording unit 502 configured as a video recorder records observational data comprising video content. The video recorder is a recorder that captures and converts a video signal into a digital data format. For video recording and image capturing units, a camera connects to the patient information processing system 505. The recording unit 502 configured as an image capture device, for example, a digital camera, a mobile video camera, etc., records observational data comprising images. The image capture device captures images of the treatment and the physical condition of the patient and transmits the images to the patient information processing system 505 of the medical personnel.

In an embodiment, the recording unit 502 configured as one or more of the audio recorder, the image capture device, and the video recorder captures speech, images, and videos, respectively, of the medical treatment provided to the patient and the physical condition of the patient. In an embodiment, the recording unit 502 configured as a text content recorder records observational data manually typed by medical personnel using a keypad of the recording unit 502. The recording unit 502 configured as a multimedia recorder captures a combination of audio content, images, video content, etc., of the treatment that the patient receives. The multimedia recorder, for example, comprises an audio recorder, a video recorder, a graphical user interface to acquire text content, etc. In an embodiment, the recording unit 502 further comprises an external microphone 507 and a headset 506 for enabling the medical personnel to record audio or voice content.

In an embodiment, the recording unit 502 comprises an array of sound sensors 502a positioned in an arbitrary configuration as disclosed in the co-pending patent application number 13/049,877 titled “Microphone Array System” filed on Mar. 16, 2011 in the United States Patent and Trademark Office. The recording unit 502 allows a flexible adjustment of position and orientation of the array of sound sensors 502a to suppress ambient noise and improve the quality of the recordings. For example, the recording unit 502 allows a flexible adjustment of position and orientation of the array of sound sensors 502a depending on the directions and levels of background noise, the distance of the array of sound sensors 502a from the speaker's mouth, etc. In an example, the array of sound sensors 502a allows the recording unit 502 to pick up sound signals from the direction of the medical personnel's mouth and suppress noise from other directions. Furthermore, the array of sound sensors 502a allows the medical personnel to operate in a hands free manner. The array of sound sensors 502a of the recording unit 502 receives the observational data of the patient.

In an embodiment, the record and playback unit 511 of the recording unit 502 reproduces the recorded observational data. For example, the record and playback unit 511 of the recording unit 502 in the patient information processing system 505 at a medical facility 509, for example, a medical treatment facility reproduces the recorded voice of the medical personnel to understand the condition of the patient. The record and playback unit 511 comprises, for example, a noise reduction speaker 508 for ensuring a high quality of sound playback and an image and video display unit that renders the images of the medical treatment received by the patient and reproduces the recorded video of the patient.

In an embodiment, the record and playback unit 511 comprises a timestamp module 511a and a speech synthesizer 511b as exemplarily illustrated in FIG. 5B. The timestamp module 511a automatically records a timestamp comprising, for example, the exact date and time at which a diagnosis of the patient was recorded by the medical personnel using the record and playback unit 511, and appends the timestamp to the recorded observational data. In an embodiment, the timestamp module 511a automatically appends timestamps to every recording of observational data that is separated by a predetermined duration of time. Further, the timestamps enable synchronization of the observational data, for example, image content with audio content and video content having the same timestamps. The timestamp information can be retrieved by medical personnel through the echelons of care, thereby ensuring that the patient, for example, is not overdosed. Successful treatment protocols can be identified based on the relevant diagnosis, dosage information, and information on the time of diagnosis and administration of treatment to the patient.

In an embodiment, the speech synthesizer 511b converts the timestamps appended to the recorded observational data to an audio format to enable audio playback of the appended timestamps along with the recorded observational data. The speech synthesizer 511b converts the text content of the timestamps to audio content and superimposes the audio content on the recorded observational data, for example, by detecting pauses or silent periods in the audio data recorded by the medical personnel and superimposing the converted timestamps in the silent periods.

In an embodiment, the recording unit 502 further comprises a data recognition module 512 and a data enhancement unit 513. The data recognition module 512 recognizes and transforms one or more of the audio content, the video content, the text content, the audiovisual content, the image content, the multimedia content, and any combination thereof, from the recorded observational data into one or more of multiple content formats, for example, a text content format, an audio content format, a video content format, an audiovisual content format, an image content format, a multimedia content format, etc. The data recognition module 512 improves recognition accuracy of audio content, video content, text content, audiovisual content, image content, multimedia content, and any combination thereof recorded using the record and playback unit 511 of the recording unit 502. In an embodiment as exemplarily illustrated in FIG. 5C, the data recognition module 512 comprises an audio recognition module 512a. The audio recognition module 512a converts audio content, for example, spoken words to text. The audio recognition module 512a identifies keywords in the audio content. For example, the audio recognition module 512a identifies keywords pertaining to predefined medical terms from the recorded utterances of the medical personnel.

In another example, the audio recognition module 512a of the recording unit 502 in the information carrier device 501 performs audio or speech recognition on a query for instructions on the treatment of the patient uttered by a responder and extracts keywords from the recorded utterances of the responder to perform a search for triage information in the knowledge base 515. In an embodiment, the audio recognition module 512a compares the speech segments extracted from the audio content with keywords extracted from the medical information database 505f of the patient information processing system 505. Consider an example where medical personnel orally record the patient's injury as a “Superficial laceration”. The audio recognition module 512a performs a search for the key phrase in the medical information database 505f. The audio recognition module 512a determines the index to which the key phrase is assigned, and using the index determines that the key phrase describes the nature of the injury sustained by the patient. The audio recognition module 512a extracts the keywords and tags the keywords to a specific field, for example, “Wound”. The tagged keywords along with the tags are transmitted as inputs to a report generation module 505e of the patient information processing system 505.

In an embodiment, the data recognition module 512 further comprises an image recognition module 512b, a video recognition module 512c, and a multimedia recognition module 512d as exemplarily illustrated in FIG. 5C, for recognizing image content, video content, and multimedia content respectively from the recorded observational data.

In an embodiment, the record and playback unit 511 of the recording unit 502 associated with the information carrier device 501 receives a query from a responder for instructions on the treatment of the patient. The data recognition module 512 performs data recognition on the query for extracting keywords from the query. For example, the audio recognition module 512a of the data recognition module 512 converts a spoken query into text to extract keywords from the query. Further, the data recognition module 512 performs a search for triage information in the knowledge base 515 using the extracted keywords. The record and playback unit 511 receives the triage information from the data recognition module 512 in one or more of multiple formats, for example, an audio format, a video format, an audiovisual format, a text format, etc., and renders the triage information in one or more of the formats, for example, an audio format, a video format, an audiovisual format, a text format, etc., on the user interface 501e of the information carrier device 501 for enabling treatment of the patient. For example, if the record and playback unit 511 receives the triage information in a text format from the data recognition module 512, the record and playback unit 511 visually displays the triage information in the text format on the user interface 501e of the information carrier device 501 for viewing and interpretation by the responder. In another example, if the record and playback unit 511 receives the triage information in an audio format from the data recognition module 512, the record and playback unit 511 audio plays back the triage information on the user interface 501e of the information carrier device 501 for hearing and interpretation by the responder. In another example, if the record and playback unit 511 receives the triage information in a video format from the data recognition module 512, the record and playback unit 511 video plays back the triage information on the user interface 501e of the information carrier device 501 for viewing and interpretation by the responder.

In an embodiment where the recording unit 502 comprises a keypad for enabling manual typing by the responder, the responder enters the query on the user interface 501e of the information carrier device 501 in a text format. The data recognition module 512 performs data recognition on the query for extracting keywords from the query. Further, the data recognition module 512 performs a search for triage information in the knowledge base 515 using the extracted keywords. The record and playback unit 511 receives the triage information from the data recognition module 512 and renders the triage information in one or more of multiple formats, for example, an audio format, a video format, an audiovisual format, a text format, etc., on the user interface 501e of the information carrier device 501 for enabling treatment of the patient.

The data enhancement unit 513 is configured to improve the signal-to-noise ratio of the recorded observational data, for example, the recorded voice or speech. The data enhancement unit 513 implements noise reduction algorithms to ensure that the speech signals are not corrupted by background noise, thereby resulting in improved speech recognition accuracy. The data enhancement unit 513 comprises an image processing module 513b, an audio processing module 513a, and a video processing module 513c as disclosed in the detailed description of FIG. 5D. In an embodiment, the data enhancement unit 513 further comprises a noise reduction module 513d as disclosed in the detailed description of FIG. 5D.

The patient information processing system 505 is in electronic communication with the information carrier device 501, the data extraction unit 504, and the recording unit 502, for example, by a wired mode of communication, a wireless mode of communication via the communication network 510, or a combination thereof. Each of the medical personnel attending to the patient is equipped with the patient information processing system 505. In an embodiment, the patient information processing system 505 is positioned at a remote medical facility 509. The patient information processing system 505 receives and manages the patient information transmitted by the data extraction unit 504 via the communication network 510 for further treatment of the patient. In an embodiment, the patient information processing system 505 directly extracts the patient information from the information carrier device 501, for example, by a wired mode of communication, a wireless mode of communication via the communication network 510, or a combination thereof.

The patient information processing system 505 comprises a communication module 505a, a processing and analysis unit 505d, a report generation module 505e, a security unit 503, a medical information database 505f, and a user interface 505c. The communication module 505a of the patient information processing system 505, comprising, for example, a transceiver receives the patient information extracted from the information carrier device 501 or transmitted by the data extraction unit 504. In an embodiment, the patient information processing system 505 further comprises a card reader 505b for accessing, reading, and extracting the patient information stored in the information carrier device 501. The communication module 505a of the patient information processing system 505 comprising, for example, a transceiver also receives the recorded observational data extracted from the record and playback unit 511 of the recording unit 502, for example, by a wired mode of communication, a wireless mode of communication via the communication network 510, or a combination thereof.

The user interface 505c of the patient information processing system 505 renders the patient information and the recorded observational data to the medical personnel operating the patient information processing system 505. The medical personnel attending to the patient can then perform the medical examination and provide accurate treatment based on the rendered patient information and the recorded observational data. The user interface 505c of the patient information processing system 505 allows the medical personnel to access and analyze the medical history of the patient from the rendered patient information. In an embodiment, the decryption module 503b of the security unit 503 in the patient information processing system 505 decrypts the secured patient information prior to rendering the patient information. The medical personnel can then proceed with providing the observational data subsequent to the medical examination and treatment of the patient. Based on the inputs that the extracted patient information provides on the medical history of the patient, the medical personnel treat the patient. The medical personnel record observations on the medical condition of the patient using the recording unit 502.

In an embodiment, the patient information processing system 505 further comprises the recording unit 502 for enabling direct recording and playback of observational data of the patient. The recording unit 502 comprises the record and playback unit 511 that records and reproduces the recorded observational data.

The processing and analysis unit 505d of the patient information processing system 505 processes and analyzes the patient information and the recorded observational data. The processing and analysis unit 505d comprises a data recognition module 512 as exemplarily illustrated in FIG. 5C. The data recognition module 512 of the processing and analysis unit 505d processes the audio content, the video content, the text content, the audiovisual content, the image content, the multimedia content, etc., of the observational data. The data recognition module 512 converts the received observational data in one of the content formats to another one or more of the content formats. In an example, the data recognition module 512 performs speech recognition, processes the observational data received as voice or speech signals, and improves speech recognition accuracy. The data recognition module 512 converts the recorded audio content into text for documenting the condition of the patient. In an embodiment, the data recognition module 512 further converts the recorded audio content into a format that matches an electronic format for a medical record, for example, a United States (US) Field Medical Card Form.

In an embodiment, the processing and analysis unit 505d of the patient information processing system 505 further comprises a selective extraction module 514 for selectively extracting information on health conditions and treatment administered to the patient from each recording of the observational data. The report generation module 505e, in communication with the selective extraction module 514, generates a health record in one or more of the formats for each recording of the observational data. The selective extraction module 514 integrates the selectively extracted information across multiple recordings of the observational data of the patient for ensuring that implicit information recorded on the health conditions and the treatment administered to the patient in one or more recordings of the observational data is explicitly recorded in each generated health record. Furthermore, the selective extraction module 514 extracts keywords from the recorded observational data, tags the extracted keywords to the generated health record associated with the recorded observational data, and stores the generated health record and the recorded observational data, for example, in a medical information database 505f of the patient information processing system 505 and the data storage unit 501a of the information carrier device 501 for enabling an expedited retrieval of the generated health record and the recorded observational data using the keywords.

The audio recognition module 512a of the data recognition module 512 of the patient information processing system 505 performs audio recognition on the audio content of the recorded observational data and obtains the text content converted from the audio content. The selective extraction module 514 selectively extracts information on the health condition and treatment administered to the patient from the text content and sends instructions to the report generation module 505e to generate a health record comprising the extracted information for each recording of the observational data.

In an embodiment, the medical information database 505f of the patient information processing system 505 collates multiple health records of multiple patients, stored in the medical information database 505f. The medical information database 505f collates the health records based on the extracted keywords for tracking injuries of the patients and medical reactions to the treatment and medicines administered to the patients.

In an embodiment, the processing and analysis unit 505d further comprises a data enhancement unit 513, as exemplarily illustrated in FIG. 5D, which improves signal-to-noise ratio and suppresses background noise of the recorded observational data. The data enhancement unit 513 improves the signal-to-noise ratio of the recorded observational data using noise reduction algorithms.

The data enhancement unit 513 comprises an audio processing module 513a, an image processing module 513b, and a video processing module 513c as exemplarily illustrated in FIG. 5D. The audio processing module 513a processes the audio content for improving the signal-to-noise ratio of the recorded audio content and for suppressing the background noise as disclosed in the detailed description of FIG. 3. The image processing module 513b processes the recorded and digitized images to reduce artifacts, for example, noise, sharpening halos, chromatic aberration, ringing artifacts, block artifacts, etc., created in the images during capture of the images of the patient's condition and treatment. The image processing module 513b reduces the artifacts in the processed images, for example, by applying filtering techniques and specialized image processing algorithms and transforms such as a discrete cosine transform. The video processing module 513c processes the recorded and digitized videos of the patient's condition and treatment and reduces the artifacts in the videos, for example, three dimensional noise, block artifacts, lossy compression, blur effects, etc., by applying specialized filtering techniques and algorithms. In an embodiment, the data enhancement unit 513 comprises a noise reduction module 513d that suppresses the background noise recorded along with the observational data for enhancing the signal-to-noise ratio of the recorded observational data. The noise reduction module 513d performs noise reduction, for example, by using a Wiener-filter based noise reduction algorithm, a spectral subtraction noise reduction algorithm, an auditory transform based noise reduction algorithm, a model based noise reduction algorithm, etc.

In an embodiment, the standalone recording unit 502 or the recording unit 502 in the information carrier device 501 and the patient information processing system 505 exemplarily illustrated in FIG. 5A, further comprises a communication module 502c comprising, for example, a transceiver for establishing bidirectional remote communication with a remote medical facility 509 to transmit the recorded observational data to the remote medical facility 509 and receive instructions from the remote medical facility 509 to determine triage information for the patient, as disclosed in the detailed description of FIG. 1. The recording unit 502 stores the triage information in the data storage unit 501a of the information carrier device 501, for example, via a wired mode of communication, a wireless mode of communication via the communication network 510, or a combination of a wired mode of communication and a wireless mode of communication.

Furthermore, the recording unit 502 performs echo cancellation, audio compression and decompression, image compression and decompression, video compression and decompression, etc., of the recorded observational data for establishing bidirectional remote communication between the recording unit 502 and the remote medical facility 509. In an example, the noise reduction module 513d of the data enhancement unit 513 exemplarily illustrated in FIG. 5D performs echo cancellation for allowing bidirectional remote communication between the recording unit 502 and the remote medical facility 509, for example, the medical treatment facility. Furthermore, the audio processing module 513a of the data enhancement unit 513 performs audio compression and decompression for expediting transmission of the recorded audio content to the remote medical facility 509 and reception of audio instructions detailing the steps of the treatment from the remote medical facility 509. The image processing module 513b of the data enhancement unit 513 performs image compression of recorded image content to be transmitted to the remote medical facility 509 or decompression of the image instructions, for example, photographs that capture the expected results on treating a particular ailment received from the remote medical facility 509. The video processing module 513c of the data enhancement unit 513 performs video compression of the recorded video content to be transmitted to the remote medical facility 509 or the decompression of video instructions received from the remote medical facility 509.

The report generation module 505e generates a medical examination report in one or more of the formats based on the processing and the analysis of the patient information and the observational data. In an embodiment, the report generation module 505e acquires audio content, image content, video content, and multimedia content from the audio recognition module 512a, the image recognition module 512b, the video recognition module 512c, and the multimedia recognition module 512d respectively, of the data recognition module 512 and uses associated keywords tagged to the audio content, the image content, the video content, and the multimedia content to populate the fields of the medical examination report. In an embodiment, the report generation module 505e of the patient information processing system 505 automatically fills the medical examination report and predefined forms using the patient information received from the information carrier device 501 and the data extraction unit 504, and the recorded observational data extracted from the recording unit 502.

The report generation module 505e stores the medical examination report in the medical information database 505f. A display unit of the patient information processing system 505 displays the generated medical examination report, via the user interface 505c, to the medical personnel operating the patient information processing system 505. The communication module 505a of the patient information processing system 505 comprising, for example, a transceiver directly transmits the generated medical examination report in one or more of the formats to the information carrier device 501 for updating the patient information in the information carrier device 501. In an embodiment, the encryption module 503a of the security unit 503 in the patient information processing system 505 encrypts the generated medical examination report prior to transmission of the generated medical examination report to the information carrier device 501.

In an embodiment, the communication module 505a of the patient information processing system 505 comprising, for example, a transceiver transmits the generated medical examination report to the information carrier device 501 via the data extraction unit 504 for updating the patient information in the information carrier device 501. That is, the data extraction unit 504 extracts the generated medical examination report from the patient information processing system 505 and transmits the generated medical examination report to the information carrier device 501 via their respective communication interfaces 504a and 501b. In another embodiment, the communication module 505a of the patient information processing system 505 comprising, for example, a transceiver transmits the generated medical examination report to the information carrier device 501 via the communication network 510. In an embodiment, the communication module 505a of the patient information processing system 505 comprising, for example, a transceiver transmits the generated medical examination report to a remote medical facility 509 via the communication network 510 for updating the patient information at the remote medical facility 509. The medical information database 505f stores the patient information, the recorded observational data, the generated medical examination report, etc., of each patient.

The security unit 503 of the patient information processing system 505 secures the patient information and the generated medical examination report. The security unit 503 comprises an encryption module 503a and a decryption module 503b. The decryption module 503b decrypts the secured patient information before rendering the patient information on the user interface 505c of the patient information processing system 505. The decryption module 503b decrypts the secured patient information to enable viewing of the patient information by the medical personnel. The decryption module 503b executes a standardized decryption algorithm. The encryption module 503a encrypts the recorded observational data and the generated medical examination report before transmission of the recorded observational data and the generated medical examination report to the information carrier device 501 and a remote medical facility 509 by the communication module 505a of the patient information processing system 505. The communication interface 501b of the information carrier device 501 receives the generated medical examination report in one or more of multiple formats based on processing and analysis of the patient information, the recorded observational data, the biomedical signals, etc., by the patient information processing system 505. The data storage unit 501a of the information carrier device 501 stores the generated medical examination report in one or more of the formats.

In an embodiment, the patient information processing system 505 of the medical personnel directly transmits the recorded observational data to the information carrier device 501, where the patient information processing system 505 is in a wired mode of communication with the information carrier device 501. In another embodiment, the patient information processing system 505 transmits the recorded observational data to the data extraction unit 504 via a wireless mode of communication. The data extraction unit 504 then transmits the recorded observational data to the information carrier device 501 via a wired mode of communication.

The updated patient information in the information carrier device 501 is accessed at the next level at a medical facility 509 such as a medical treatment facility before further treatment is provided to the patient. In an example, the patient information is updated during transport of the patient to the medical facility 509. The patient information, for example, the patient's medical records are updated in the information carrier device 501 continuously or at predetermined time intervals by the medical personnel during the transport of the patient to the medical facility 509. In an embodiment, the recording unit 502 associated with the information carrier device 501 automatically updates the patient information with the recorded observational data in the information carrier device 501. The medical personnel can extract the patient information comprising the medical history of the patient from the information carrier device 501, for example, using the data extraction unit 504 or directly via the communication interface 501b. The medical personnel can record the observational data while the patient is being transported to a next level of treatment at a medical facility 509 and when the medical personnel have multiple information carrier devices 501. For example, in a non-military emergency scenario, the medical personnel may have multiple information carrier devices 501 at their disposal. The medical personnel can select an information carrier device 501, record the observational data on the information carrier device 501, and affix the information carrier device 501 to a patient, to enable the patient to carry the observational data to a medical facility 509. Medical personnel can record additional medical observations and treatment procedures administered to the patient using the recording unit 502, update the recorded observational data in the information carrier device 501 using the patient information processing system 505, and affix the information carrier device 501 to the patient. Therefore, the data extraction unit 504, the recording unit 502, the communication interface 501b, etc., allow constant access and updation of the patient information to the information carrier device 501 during the transport of the patient from the point at which the initial treatment was administered by a first responder to the highest echelon of care.

The patient then carries the information carrier device 501 with the updated patient information to the next medical facility 509. The patient information is extracted from the information carrier device 501, for example, using the data extraction unit 504 and analyzed by medical personnel for further treatment. Furthermore, the data recognition module 512 in the patient information processing system 505 at the medical facility 509 processes the additionally recorded observational data, fills in medical records that are extracted from the patient information processing system 505 of the medical personnel using the report generation module 505e, and updates the patient information in the information carrier device 501 carried by the patient via the communication module 505a of the patient information processing system 505.

In an embodiment, the patient information processing system 505 further comprises a wireless communication dongle 503c. The wireless communication dongle 503c is a hardware component that provides wireless capabilities to the patient information processing system 505 held by the medical personnel or stationed at a remote medical facility 509, if the patient information processing system 505 does not already possess wireless capabilities. The wireless communication dongle 503c enables wireless communication with the data extraction unit 504. The wireless communication dongle 503c communicates over a wireless interface with the data extraction unit 504 to which the information carrier device 501 is electronically connected. The wireless interface supports various wireless technology standards, for example, Bluetooth®, Wi-Fi®, etc. The wireless communication dongle 503c provides wireless communication capability to the patient information processing system 505.

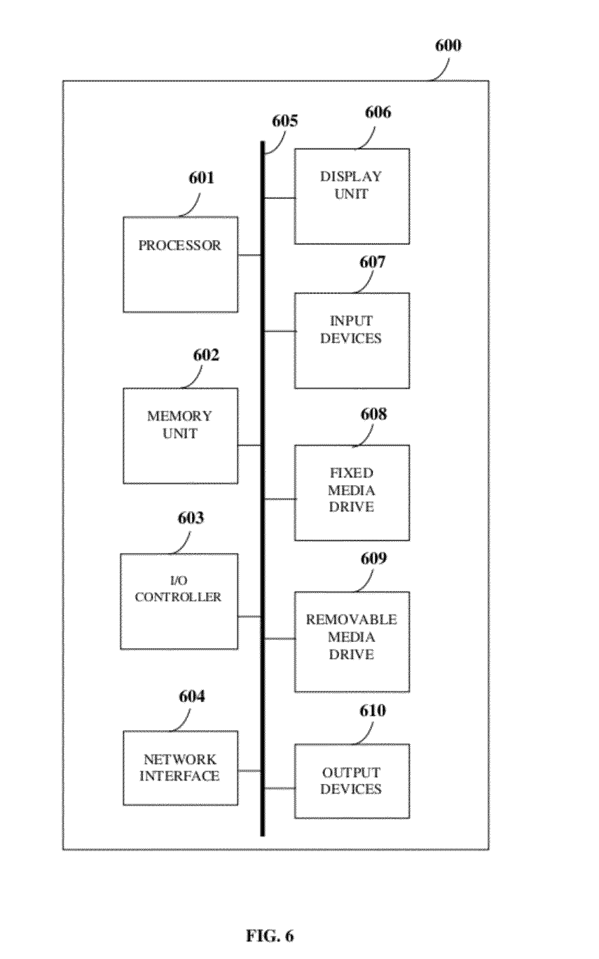

FIG. 6 exemplarily illustrates the architecture of a computer system 600 employed for documenting and managing patient information in real time for accurate medical examination and treatment of a patient. The patient information processing system 505 of the system 500 exemplarily illustrated in FIG. 5A employs the architecture of the computer system 600 exemplarily illustrated in FIG. 6.

The patient information processing system 505 operated by medical personnel communicates with the information carrier device 501, the data extraction unit 504, and the recording unit 502, for example, by a wired mode of communication, a wireless mode of communication via the communication network 510, and a combination thereof. The communication network 510 is, for example, a short range network or a long range network. The computer system 600 comprises, for example, a processor 601, a memory unit 602 for storing programs and data, an input/output (I/O) controller 606, a network interface 604, a data bus 605, a display unit 606, input devices 607, a fixed media drive 608, a removable media drive 609 for receiving removable media, output devices 610, etc.

The processor 601 is an electronic circuit that can execute computer programs. The memory unit 602 stores programs, applications, and data. For example, the processing and analysis unit 505d, the report generation module 505e, and the security unit 503 of the patient information processing system 505 are stored in the memory unit 602 of the computer system 600. The memory unit 602 is, for example, a random access memory (RAM) or another type of dynamic storage device that stores information and instructions for execution by the processor 601. The memory unit 602 also stores temporary variables and other intermediate information used during execution of the instructions by the processor 601. The computer system 600 further comprises a read only memory (ROM) or another type of static storage device that stores static information and instructions for the processor 601. The network interface 604 enables connection of the computer system 600 to the communication network 510. The computer system 600 of the patient information processing system 505 communicates with other interacting devices, for example, the data extraction unit 504, the information carrier device 501, etc., through the network interface 604. The network interface 604 comprises, for example, a Bluetooth® interface, an infrared (IR) interface, an interface that implements Wi-Fi® of the Wireless Ethernet Compatibility Alliance, Inc., a universal serial bus (USB) interface, a local area network (LAN) interface, a wide area network (WAN) interface, etc. The I/O controller 606 controls the input and output actions performed by medical personnel using the patient information processing system 505. The data bus 605 permits communications between the modules, for example, 505d, 505e, 505f, 502, etc., of the system 500 disclosed herein.

The display unit 606 displays, via the user interface 505c, the received patient information to the medical personnel. The display unit 606, for example, displays icons, text fields, etc., to enable the medical personnel to input the patient information, highlight specific objects in the images of the patient, etc. The input devices 607 are used for inputting data into the computer system 600. The input devices 607 are, for example, a keyboard such as an alphanumeric keyboard, a joystick, a computer mouse, a touch pad, a light pen, a digital pen, a microphone 507, a digital camera, etc.

In an embodiment, the removable media drive 609 of the computer system 600 comprises a card reader 505b. The information carrier device 501 comprising, for example, an electronic memory card, is inserted into the card reader 505b for extracting the patient information from the information carrier device 501. The output devices 610 output the results of the actions computed by the patient information processing system 505, for example, to the medical personnel.

Computer applications and programs are used for operating the computer system 600. The programs are loaded onto the fixed media drive 608 and into the memory unit 602 of the computer system 600 via the removable media drive 609. In an embodiment, the computer applications and programs may be loaded directly via the communication network 510. Computer applications and programs are executed by double clicking a related icon displayed on the display unit 606 using one of the input devices 607.

The computer system 600 of the patient information processing system 505 that manages patient information retrieved from the information carrier device 501 employs an operating system for performing multiple tasks. The operating system is responsible for the management and coordination of activities and the sharing of the resources of the computer system 600. The operating system further manages security of the computer system 600, peripheral devices connected to the computer system 600, and network connections. The operating system employed on the computer system 600 recognizes, for example, inputs provided by the medical personnel using one of the input devices 607, the output display, files, and directories stored locally on the fixed media drive 608, for example, a hard drive. The operating system on the computer system 600 executes different programs, for example, an audio recorder program, a speech recognition program, a disk encryption program, etc., using the processor 601. The processor 601 retrieves the instructions for executing the modules, for example, 505a, 505d, 505e, 505f, etc., of the patient information processing system 505 from the memory unit 602 in the form of signals. A program counter determines the location of the instructions in the memory unit 602. The program counter stores a number that identifies the current position in the program of the modules, for example, 505a, 505d, 505e, 505f, etc., of the patient information processing system 505.

The instructions fetched by the processor 601 from the memory unit 602 after being processed are decoded. The instructions are placed in an instruction register in the processor 601. After processing and decoding, the processor 601 executes the instructions. For example, the processing and analysis unit 505d defines instructions for processing and analyzing the patient information extracted from the information carrier device 501 directly or via the data extraction unit 504, and the observational data extracted from the record and playback unit 511 of the recording unit 502. The data recognition module 512 defines instructions for recognizing and transforming one or more of the audio content, the video content, the text content, the audiovisual content, the image content, the multimedia content, and any combination thereof, from the recorded observational data into one or more of multiple content formats, for example, a text content format, an audio content format, a video content format, an audiovisual content format, an image content format, a multimedia content format, etc. The data recognition module 512 also defines instructions for processing and improving recognition accuracy of audio content, video content, text content, audiovisual content, image content, multimedia content, and any combination thereof recorded using the recording unit 502.

The data recognition module 512 of the recording unit 502 associated with the information carrier device 501 defines instructions for receiving a query from a responder for instructions on the treatment of the patient. The data recognition module 512 defines instructions for performing data recognition on the query for extracting keywords from the query. Further, the data recognition module 512 defines instructions for performing a search for triage information in the knowledge base 515 using the extracted keywords. The record and playback unit 511 of the recording unit 502 defines instructions for receiving the triage information from the data recognition module 512 and rendering the triage information in one or more of multiple formats, for example, an audio format, a video format, an audiovisual format, a text format, etc., on the user interface 501e of the information carrier device 501 for enabling treatment of the patient. The data enhancement unit 513 defines instructions for implementing noise reduction algorithms to ensure that the speech signals are not corrupted by background noise. The timestamp module 511a of the record and playback unit 511 defines instructions for automatically appending a timestamp to the recorded observational data during the recording of the observational data by the recording unit 502. The speech synthesizer 511b of the record and playback unit 511 defines instructions for converting the appended timestamp to an audio format to enable audio playback of the appended timestamp along with the recorded observational data.

The security unit 503 defines instructions for decrypting the received patient information and encrypting the generated medical examination report. The report generation module 505e defines instructions for generating a medical examination report in one or more of the formats based on the processing and the analysis of the patient information and the observational data, where the communication module 505a comprising, for example, a transceiver transmits the generated medical examination report in one or more of the formats to the information carrier device 501 for updating the patient information in the information carrier device 501. In an embodiment, the report generation module 505e defines instructions for automatically filling the medical examination report and predefined forms using the patient information received from the information carrier device 501 and/or the data extraction unit 504, and the recorded observational data extracted from the recording unit 502. The communication module 505a of the patient information processing system 505 defines instructions for transmitting the generated medical examination report in one or more of the formats to the information carrier device 501 for updating the patient information in the information carrier device 501.

The monitoring module 501d of the information carrier device 501 defines instructions for monitoring biomedical signals of the patient for verifying vital signs of the patient and biometrically tracking identity of the patient. The alarm notification module 501f defines instructions for generating an alarm notification, for example, on detecting a divergence of the vital signs of the patient from preconfigured settings in the information carrier device 501, on detecting a loss of signal contact between the information carrier device 501 and external responder devices, or on detecting a misassociation between the information carrier device 501 and the patient, etc. The security unit 503 defines instructions for securing the patient information in the information carrier device 501.

The selective extraction module 514 of the processing and analysis unit 505d of the patient information processing system 505 defines instructions for selectively extracting information on health conditions and treatment administered to the patient from each recording of the observational data. The report generation module 505e defines instructions for generating a health record for each recording of the observational data. Furthermore, the selective extraction module 514 defines instructions for integrating the selectively extracted information across multiple recordings of the observational data of the patient for ensuring that implicit information recorded on the health conditions and the treatment administered to the patient in one or more recordings of the observational data is explicitly recorded in each generated health record. The selective extraction module 514 also defines instructions for extracting keywords from the recorded observational data, tagging the extracted keywords to the generated health record associated with the recorded observational data, and storing the generated health record and the recorded observational data in the medical information database 505f of the patient information processing system 505, the data storage unit 501a of the information carrier device 501, etc., for enabling an expedited retrieval of the generated health record and the recorded observational data using the keywords.

The medical information database 505f defines instructions for collating multiple health records of multiple patients stored in the medical information database 505f of the patient information processing system 505 based on the extracted keywords for tracking injuries of the patients and medical reactions to the treatment and medicines administered to the patients.

The noise reduction module 513d of the data enhancement unit 513, exemplarily illustrated in FIG. 5D, defines instructions for performing echo cancellation for allowing bidirectional remote communication between the recording unit 502 and a remote medical facility 509. The audio processing module 513a of the data enhancement unit 513, exemplarily illustrated in FIG. 5D, defines instructions for performing audio compression and decompression for expediting transmission of the recorded audio content to the remote medical facility 509 and reception of audio instructions detailing the steps of the treatment from the remote medical facility 509. The image processing module 513b of the data enhancement unit 513, exemplarily illustrated in FIG. 5D, defines instructions for performing image compression of the recorded image content to be transmitted to the remote medical facility 509 or decompression of the image instructions, for example, photographs that capture the expected results on treating a particular ailment received from the remote medical facility 509. The video processing module 513c of the data enhancement unit 513, exemplarily illustrated in FIG. 5D, defines instructions for performing video compression of the recorded video content to be transmitted to the remote medical facility 509 or the decompression of the video instructions received from the remote medical facility 509.

The processor 601 of the patient information processing system 505 retrieves the instructions defined by the processing and analysis unit 505d, the data recognition module 512, the modules 513a, 513b, 513c, and 513d of the data enhancement unit 513, the selective extraction module 514, the security unit 503, the modules 511a and 511b of the record and playback unit 511, the recording unit 502, the report generation module 505e, the communication module 505a, and the medical information database 505f, and executes the instructions. A processor of the information carrier device 501 retrieves the instructions defined by the data recognition module 512 of the recording unit 502, the modules 511a and 511b of the record and playback unit 511 of the recording unit 502, the data enhancement unit 513, the security unit 503, the monitoring module 501d, and the alarm notification module 501f, and executes the instructions.

At the time of execution, the instructions stored in the instruction register are examined to determine the operations to be performed. The processor 601 then performs the specified operations. The operations comprise arithmetic operations and logic operations. The operating system performs multiple routines for performing a number of tasks required to assign the input devices 607, the output devices 610, and memory for execution of the modules, for example, 505a, 505d, 505e, 505f, 502, etc., of the patient information processing system 505. The tasks performed by the operating system comprise assigning memory to the modules, for example, 505a, 505d, 505e, 505f, 502, etc., of the patient information processing system 505 and data, moving data between the memory unit 602 and disk units, and handling input/output operations. The operating system performs the tasks on request by the operations and after performing the tasks, the operating system transfers the execution control back to the processor 601. The processor 601 continues the execution to obtain one or more outputs. The outputs of the execution of the modules, for example, 505a, 505d, 505e, 505f, 502, etc., of the patient information processing system 505 are rendered to the medical personnel via the user interface 505c of the patient information processing system 505.

Disclosed herein is also a computer program product comprising computer executable instructions embodied in a non-transitory computer readable storage medium. As used herein, the term “non-transitory computer readable storage medium” refers to all computer readable media, for example, non-volatile media such as optical disks or magnetic disks, volatile media such as a register memory, a processor cache, etc., and transmission media such as wires that constitute a system bus coupled to the processor 301, except for a transitory, propagating signal.

The computer program product disclosed herein comprises multiple computer program codes for documenting and managing patient information in real time for accurate medical examination and treatment of a patient. For example, the computer program product disclosed herein comprises a first computer program code for extracting patient information from the information carrier device 501 and/or the data extraction unit 504 by the patient information processing system 505, for example, by a wired mode of communication, a wireless mode of communication via the communication network 510, or a combination thereof; a second computer program code for receiving observational data comprising medical examination information and information on treatment prescribed for a patient recorded using the recording unit 502 by the patient information processing system 505, for example, by a wired mode of communication, a wireless mode of communication via the communication network 510, or a combination thereof; a third computer program code for processing and analyzing the extracted patient information and the recorded observational data by the patient information processing system 505; a fourth computer program code for generating a medical examination report in one or more of the formats based on the processing and the analysis of the extracted patient information and the recorded observational data by the patient information processing system 505; and a fifth computer program code for transmitting the generated medical examination report in one or more of the formats to the information carrier device 501 by the patient information processing system 505, for example, by a wired mode of communication, a wireless mode of communication via the communication network 510, or a combination thereof for updating the patient information in the information carrier device 501, whereby the generation of the medical examination report in one or more of the formats and the updation of the patient information in the information carrier device 501 enable documentation and management of the patient information in real time for accurate medical examination and treatment of the patient.

In an embodiment, the computer program product disclosed herein further comprises a sixth computer program code for selectively extracting information on health conditions and treatment administered to the patient from each recording of the observational data for generating a health record for each recording of the observational data; a seventh computer program code for extracting keywords from the recorded observational data, tagging the extracted keywords to the generated health record associated with the recorded observational data, and storing the generated health record and the recorded observational data in the medical information database 505f for enabling an expedited retrieval of the generated health record and the recorded observational data using the keywords; and an eighth computer program code for collating multiple health records of multiple patients stored in the medical information database 505f based on the keywords for tracking injuries of the patients and medical reactions to the treatment and medicines administered to the patients. The computer program product disclosed herein further comprises additional computer program codes for performing additional steps that may be required and contemplated for documenting and managing patient information in real time for accurate medical examination and treatment of a patient.

The computer program codes comprising the computer executable instructions are embodied on the non-transitory computer readable storage medium. The processor 601 of the computer system 600 retrieves these computer executable instructions and executes them. When the computer executable instructions are executed by the processor 601, the computer executable instructions cause the processor 601 to perform the method steps for documenting and managing patient information in real time for accurate medical examination and treatment of a patient. In an embodiment, a single piece of computer program code comprising computer executable instructions performs one or more steps of the method disclosed herein for documenting and managing patient information in real time for accurate medical examination and treatment of a patient.

For purposes of illustration, the detailed description refers to the patient information processing system 505 being run locally on the computer system 600; however the scope of the method and system 500 disclosed herein is not limited to the patient information processing system 505 being run locally on the computer system 600 via the operating system and the processor 601 but may be extended to run remotely over the communication network 510, for example, by employing a web browser and a remote server, a mobile phone, or other electronic devices.

FIG. 7 exemplarily illustrates a screenshot of a user interface 505c rendering a medical examination report generated by the patient information processing system 505. Consider an example where the recording unit 502 of the patient information processing system 505, exemplarily illustrated in FIG. 5A, records the observational data uttered by medical personnel in the form of an audio file. The medical personnel clicks on the “Recognize” button 701 provided on the user interface 505c. The “Recognize” button 701 triggers the audio recognition module 512a, exemplarily illustrated in FIG. 5C, of the patient information processing system 505 to perform audio recognition of the audio file and convert the audio content to text content. The audio recognition module 512a transmits the text content as input to the report generation module 505e. A battlefield medical information system telemedicine (BMIST) application integrated into the patient information processing system 505 generates an electronic medical form. The electronic medical form comprises fields for entering personal information, identification information, and contact information of the patient, for example, the name, gender, social security number, religion, nationality, military rank, military branch, etc., of the patient. Further, the electronic medical form comprises fields for entering the medical condition of the patient, the position of a wound, etc. The report generation module 505e retrieves the electronic medical form from the BMIST application and populates the fields of the electronic medical form with the text content to generate the medical examination report.

FIG. 8 exemplarily illustrates a block diagram of a system 800 employed by the recording unit 502, exemplarily illustrated in FIG. 5A, for improving the signal-to-noise ratio of the recorded observational data. The recording unit 502 implements a noise reduction algorithm for improving the signal-to-noise ratio of the recorded observational data by employing the system 800 comprising an analysis filter bank 801 that acts as a frequency analysis component for performing frequency analysis, a filtering component 802 for performing temporal filtering, for example, using an adaptive Wiener filter 802d, and a synthesis filter bank 803 for performing frequency synthesis to retrieve the original observational data.

The analysis filter bank 801 performs frequency analysis by transforming a wideband noisy speech sequence into a frequency domain such that a subsequent analysis can be performed on a sub-band basis. For example, the analysis filter bank 801 applies a short-time discrete Fourier transform (DFT) for transforming the wideband noisy speech sequence into the frequency domain. The bandwidth of each sub-band is given by the ratio of the sampling frequency to the transformed length.

The filtering component 802 implements the next step of the noise reduction algorithm that is, performing temporal filtering using an adaptive Wiener filter 802d which estimates a clean speech spectrum from a noisy speech spectrum. The filtering component 802 comprises a target speech statistics analyzer 802a, a noise statistics analyzer 802b, a signal-to-noise ratio analyzer 802c, and the Wiener filter 802d. The target speech statistics analyzer 802a extracts the short-term and long-term statistics of the speech samples. The noise statistics analyzer 802b extracts the short-term and long-term statistics of the noise samples. The signal-to-noise ratio analyzer 802c analyzes the segmental wide and narrow band signal-to-noise ratio (SNR) of the noisy speech samples for performing an estimation of the gain of the Wiener filter 802d. The noisy speech spectrum passes through to the Wiener filter 802d, which generates an estimate of the clean speech spectrum. The synthesis filter bank 803 performs filter-bank synthesis as an inverse procedure of the frequency analysis, for example, using an inverse discrete Fourier transform (IDFT) and reconstructs the clean speech signal using the estimated clean speech spectrum.

FIGS. 9A-9G exemplarily illustrate graphical representations of results of applying a spectral subtraction algorithm to the recorded observational data. The recorded observational data comprises, for example, a noisy speech signal. The time domain representation of the original recorded observational data comprising the noisy speech signal is exemplarily illustrated in FIG. 9A. FIG. 9B exemplarily illustrates a time domain representation of the result of applying a spectral subtraction algorithm employed by the recording unit 502, exemplarily illustrated in FIG. 5A, for improving the signal-to-noise ratio of the recorded observational data. A spectrogram of the original recorded observational data shown in FIG. 9A is exemplarily illustrated in FIG. 9C. The spectral subtraction algorithm is designed to reduce the degrading effects of noise acoustically added in speech signals. The spectral subtraction algorithm estimates a magnitude frequency spectrum of the clean speech signal by subtracting a noise magnitude spectrum from the noisy speech spectrum.

A spectrogram of the clean speech signal is exemplarily illustrated in FIG. 9D. The difference between real noise and estimated noise is referred to as the “noise residual”. The noise residual is a series of disorderly spaced narrow bands with magnitude spikes as exemplarily illustrated in the spectrogram in FIG. 9D. After applying spectral subtraction, the noise is removed from the signal; however, the noise residual continues to be present in the clean speech signal. Once the spectrally subtracted speech signal is transformed back into the time domain, the spikes, for example, sound similar to the sum of tone generators with random frequencies. This phenomenon is known as music noise.

In the method disclosed herein, the music noise is reduced by applying, for example, smoothing factors both in a frequency domain and a time domain. In another method of reducing music noise, the recording unit 502 first applies Wiener filtering, and then applies spectral subtraction. Since the noise level is already reduced after Wiener filtering, the noise residual after spectral subtraction is low enough to be masked by the speech signal. The spectrograms recording the spectral density of the original noisy speech signal, the spectral density of the noisy speech signal subsequent to Wiener filtering, and the spectral density of the noisy speech signal subsequent to application of the spectral subtraction algorithm are exemplarily illustrated in FIG. 9E, FIG. 9F, and FIG. 9G respectively.

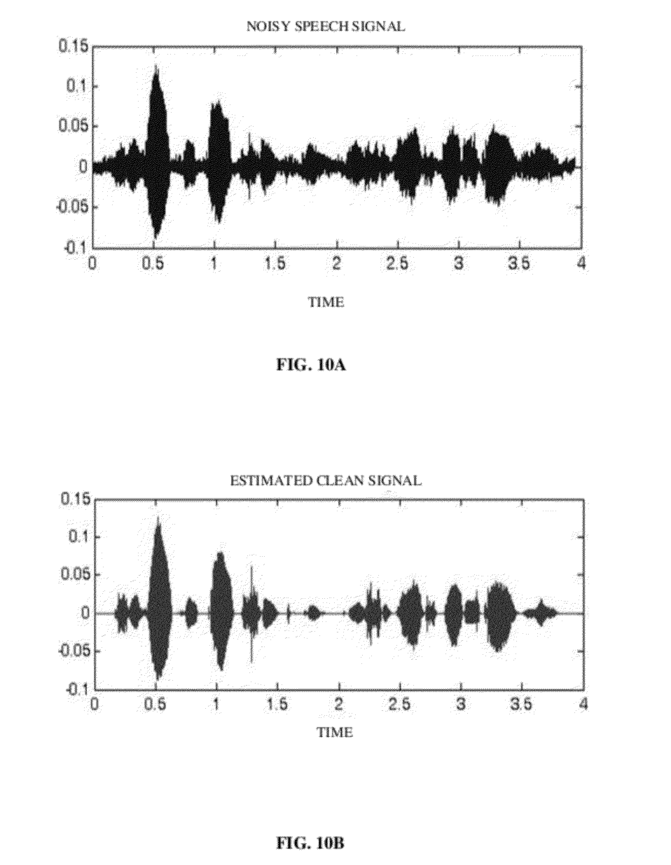

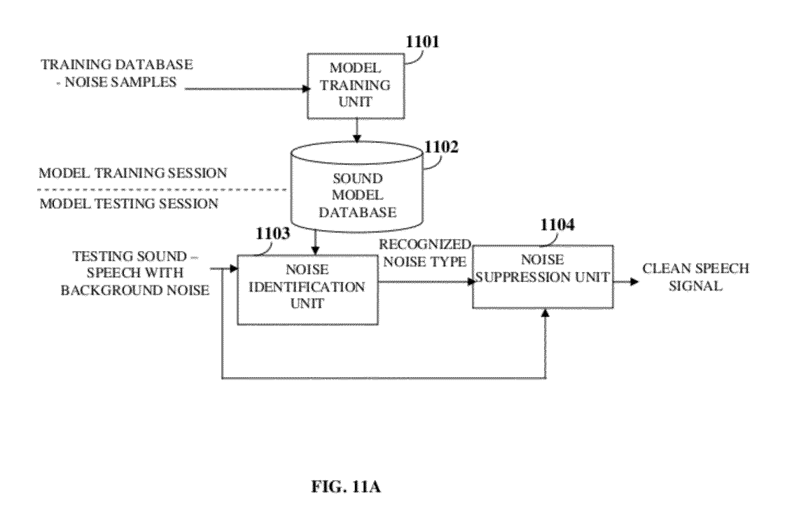

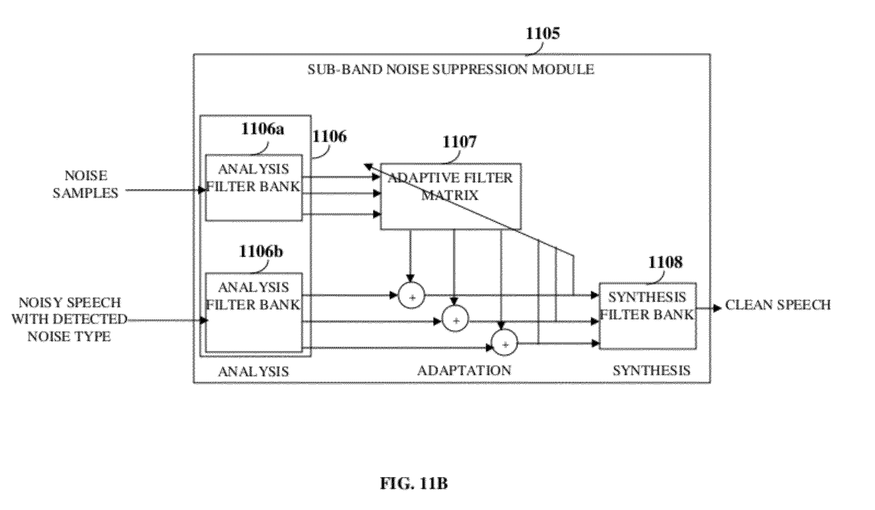

FIGS. 10A-10B exemplarily illustrate graphical representations of signals obtained on applying a cochlear transform algorithm to the recorded observational data, for suppressing background noise and improving the signal-to-noise ratio of the recorded observational data. The recorded observational data comprises, for example, a noisy speech signal. A graphical representation of the noisy speech signal is exemplarily illustrated in FIG. 10A. The cochlear transform algorithm is a broadband noise suppression algorithm that takes advantage of the structural correlations in speech signals as opposed to the broad frequency spread of noise signals. The algorithm makes use of the cochlear transform (CT) for noisy speech analysis. The cochlear transform algorithm utilizes the cochlear transform to decompose the noisy speech signal into aurally meaningful band-limited signals and adaptively processes each of the band-limited signals that are output by the cochlear transform.

The processing involves an automatic detection of noise and speech samples in each of the sub-bands. The noise samples are suppressed while the speech samples are passed though undistorted. The processed data is re-synthesized with the inverse cochlear transform (ICT) to generate a speech signal with the required noise suppression characteristics along with minimal speech distortion. The resulting noise suppressed speech signal is recovered after all the band-limited signals have been processed. The inverse cochlear transform is applied to combine the processed signal and recreate an estimate of the clean speech signal. FIG. 10B exemplarily illustrates the estimated clean speech signal that indicates the performance of the cochlear transform algorithm in removing background noise from a noisy speech signal.

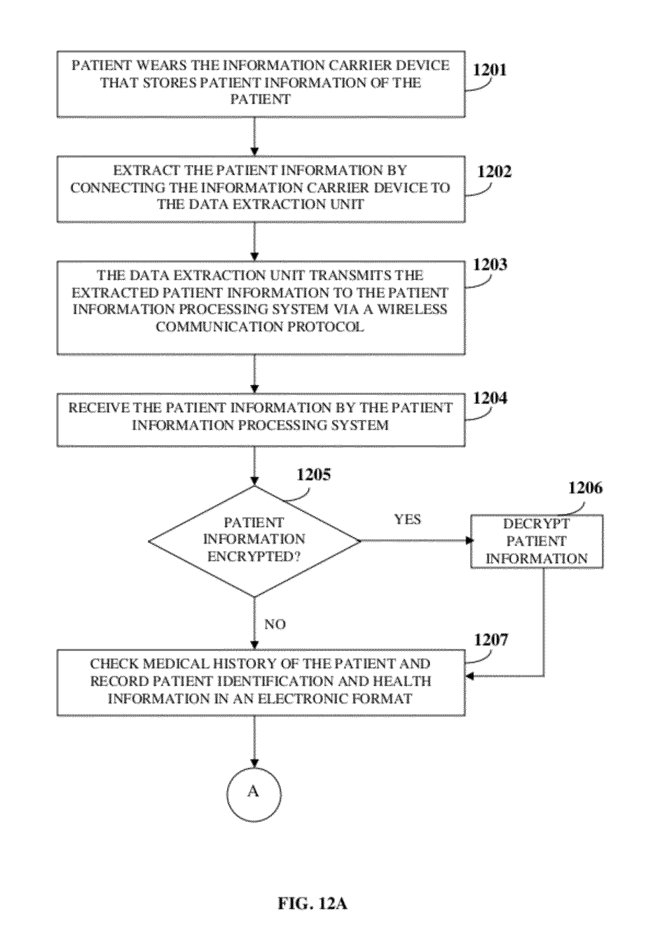

FIGS. 11A-11B exemplarily illustrate block diagrams of systems for suppressing background noise and improving the signal-to-noise ratio of the recorded observational data. The recorded observational data comprises, for example, a noisy speech signal. In addition to an extremely noisy environment, there are a number of additional noises that may be generated in a wartime scenario. Spectral models are created for detecting noises with a known spectral pattern. Once detected, a de-noise technique referred to as a model-based noise cancellation algorithm is applied to cancel the noise signals. As exemplarily illustrated in FIG. 11A, the model-based noise cancellation algorithm employs two sessions: a model training session and a model testing session. In the model training session, all possible known sounds, for example, battlefield noise samples are first recorded and saved in a training database. In the model training session, a model training unit 1101 trains a Gaussian mixture model or a hidden Markov model to represent the statistical characteristics of a particular kind of sound. For each kind of sound, the model training unit 1101 trains the sound model and saves the sound model in the sound model database 1102. During a testing session, for example, when a sound signal is detected, a noise identification unit 1103 employs a decoder for decoding and computing “likelihood scores” of the sound with a group of pre-trained sound models; thus, each sound model stored in the sound model database 1102 has an associated score. The noise identification unit 1103 selects the sound model with the largest score as the recognized sound model. This sound is therefore identified as the noise to be cancelled. A noise suppression unit 1104 performs noise cancellation on the identified noise, for example, using a sub-band noise suppression module 1105 exemplarily illustrated in FIG. 11B and cancels the noise from the noisy speech signal.

The sub-band noise suppression module 1105 exemplarily illustrated in FIG. 11B causes lesser distortion to the speech signal when compared to a full-band noise suppression model. The sub-band noise suppression module 1105 employs a set of analysis filter banks 1106 that decompose the input signal into separate components, with each component carrying a single frequency sub-band of the original signal. A first set of analysis filter banks 1106a decompose the inputted battlefield noise samples according to a specific type of battlefield noise, for example, machine gunfire, explosion, artillery, etc. Each of the different types of battlefield noises occupies different frequency sub-bands and are separated accordingly. A second set of analysis filter banks 1106b receive noisy speech signal samples as input with the type of noise already detected, and decompose the noisy speech samples into noisy speech frequency sub-bands. The decomposed noise samples and noisy speech samples are passed to an adaptation stage implemented by a adaptive filter matrix 1107. The sub-band noise suppression module 1105 employs the adaptive filter matrix 1107 for filtering the frequency sub-bands of the battlefield noise samples in order to generate battlefield noise samples that can be compared with the reference noisy speech samples in the frequency sub-bands. Therefore, the battlefield noise samples are compared with the noisy speech samples, and the noise component is adaptively removed until the sub-band error energy is minimized. The synthesis filter bank 1108 synthesizes clean speech signal samples from each of the frequency sub-bands, derived from the step of adaptation, to reconstruct a clean speech signal.

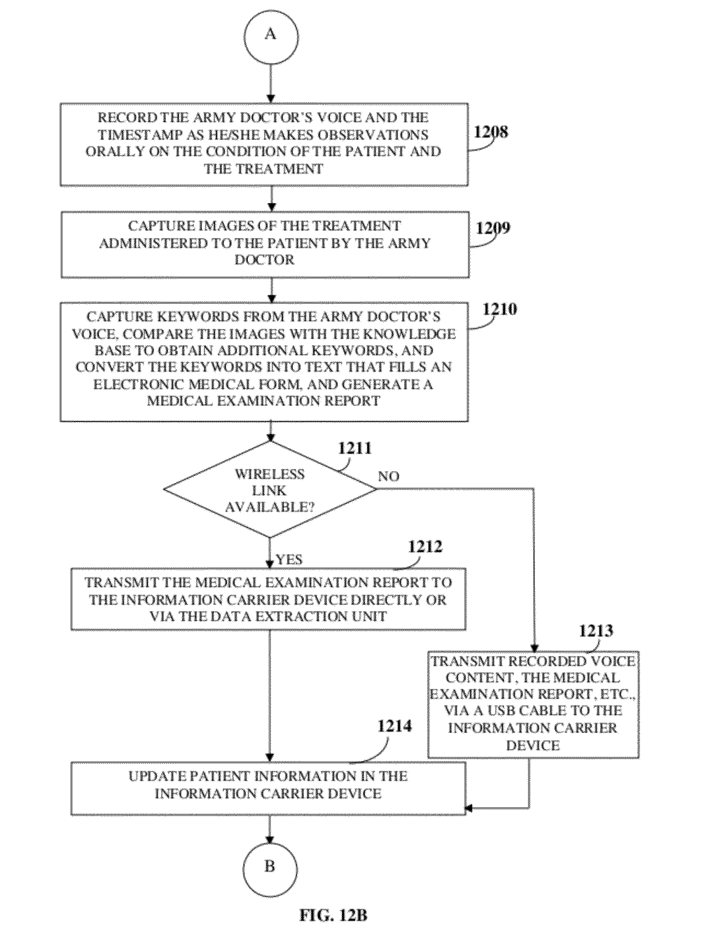

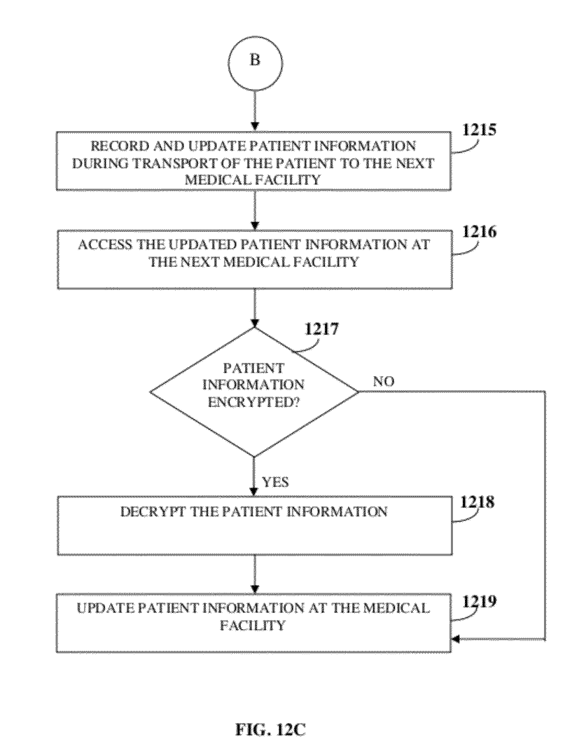

FIGS. 12A-12C exemplarily illustrate a flowchart comprising the steps for documenting and managing patient information in real time for accurate medical examination and treatment of a patient in an emergency situation. Consider an example of an emergency situation in a wartime scenario. The patient is, for example, a wounded soldier who wears 1201 the information carrier device 501, exemplarily illustrated in FIG. 5A, affixed to an electronic identification tag. The information carrier device 501 stores the patient information comprising, for example, identification information, biometric information, medical records, etc., of the patient. A medical practitioner, for example, an army doctor, who attends to the patient extracts 1202 the patient information of the soldier by connecting the information carrier device 501 to the data extraction unit 504. The data extraction unit 504, exemplarily illustrated in FIG. 5A, extracts the patient information from the information carrier device 501 and transmits 1203 the extracted patient information to the army doctor's patient information processing system 505 implemented on a laptop or other computing device via a wireless communication protocol, for example, a Bluetooth® communication protocol.

The patient information processing system 505, exemplarily illustrated in FIG. 5A, receives 1204 the patient information. The patient information processing system 505 checks 1205 whether the patient information is encrypted. If the patient information is encrypted, the decryption module 503b in the security unit 503 of the patient information processing system 505 decrypts 1206 the patient information. The army doctor then checks the medical history of the patient and records 1207 patient identification and health information in an electronic format. Based on the medical history of the patient, the army doctor analyzes the medical condition of the patient and proceeds with further examination and treatment of the wounded patient. The army doctor analyzes the condition of the patient based on the extracted patient information and physical examination of the patient and decides on the treatment to be provided to the patient. The army doctor then records observational data comprising observations made during the physical examination of the patient and the treatment administered to the patient. The army doctor records the observational data using the recording unit 502.

The recording unit 502, in this example, is an audio recorder that records 1208 the army doctor's voice and the timestamp as he/she makes observations orally on the condition of the patient and the treatment. The recording unit 502 automatically appends a timestamp for each diagnosis performed on the patient by the army doctor. In another example, the recording unit 502 is an image recorder that captures 1209 images of the treatment administered to the patient by the army doctor. In this example, the images comprise photographs of the injuries, the first aid treatment provided to the patient, etc. The audio recognition module 512a of the data recognition module 512, exemplarily illustrated in FIG. 5C, of the patient information processing system 505 captures 1210 keywords comprising diagnostic information and treatment information provided by the army doctor, from the army doctor's voice, compares the images with the knowledge base 515 to obtain additional keywords, and converts the captured keywords into text that fills an electronic medical form. The report generation module 505e of the patient information processing system 505 then generates 1210 a medical examination report based on the analysis of the patient information and the recorded voice content. The encryption module 503a of the security unit 503 of the patient information processing system 505 encrypts the recorded voice content, the electronic medical form, and the medical examination report.

The patient information processing system 505 checks 1211 whether a wireless link is available to the information carrier device 501. If the wireless link is available, the patient information processing system 505 transmits 1212 the medical examination report back to the information carrier device 501 directly or via the data extraction unit 504 over the wireless link for updating 1214 the patient information in the information carrier device 501. The patient information processing system 505 may also transmit the recorded voice content, the electronic medical form, etc., to the information carrier device 501 for updating 1214 the patient information in the information carrier device 501. If the wireless link is not available, the patient information processing system 505 directly transmits 1213 the recorded voice content, the medical examination report, the electronic medical form, etc., via a USB cable to the information carrier device 501, thereby updating 1214 the patient information in the information carrier device 501. The medical personnel traveling with the wounded soldier during transport of the patient to the next medical facility 509 access the observational data and the timestamp to determine details of the prior diagnosis conducted on the patient, the treatment administered to the patient, and the time at which a particular diagnosis and treatment was administered. The medical personnel further records and updates 1215 the patient information, for example, the condition of the patient, using the recording unit 502 during transport of the patient to the next medical facility 509.

Medical personnel at the next medical facility 509 access 1216 the updated patient information, for example, via the data extraction unit 504 over a Bluetooth® interface. In an embodiment, a wireless communication dongle 503c that is affixed to the patient information processing system 505 provides wireless capability to the patient information processing system 505. The patient information processing system 505 at the medical facility 509 checks 1217 whether the patient information is encrypted. If the patient information is encrypted, the patient information processing system 505 at the medical facility 509 decrypts 1218 the encrypted patient information and updates 1219 the patient information at the medical facility 509. If the patient information is not encrypted, the patient information processing system 505 at the medical facility 509 directly updates 1219 the patient information at the medical facility 509 after further treatment of the patient and transmits a copy of the updated patient information back to the information carrier device 501.

The aforementioned example can be extended to cover other methods of recording and documenting observational data. For example, medical personnel treating a patient can be notified of the diagnosis and the treatment administered to the patient through all the prior echelons of care. The method and system 500 disclosed herein can be used by medical personnel to administer remote treatment to the patient. For example, the medical personnel operating at the lower echelons of care such as paramedics, first responders, etc., can communicate basic information on the treatment provided to the patient to more qualified medical personnel via the information carrier device 501, the recording unit 502, and/or the patient information processing system 505. The first responders may not be able to communicate the medical condition of the patient in complete detail, or else may not be left with sufficient time to record the details of the treatment. Therefore, recording audio content, video content, and/or multimedia content of the treatment administered to the patient aids qualified medical personnel in understanding the treatment provided to the patient by the first responders. The multimedia content is created by augmenting the recorded video content, with text content, for example, notes, labels, etc., that are relevant to understanding the treatment. In an example, the medical personnel treating the patient can graphically highlight a particular area on an image of the patient via the user interface 505c of the patient information processing system 505 to indicate the location of an injury. In another example, the timestamps that record the date and time at which observations were recorded on the patient by the medical personnel is augmented onto the video content.

The scope of usage of the information carrier device 501 is extended to cover the needs of many applications. For example, the information carrier device 501 acts as a user storage device that provides identification information about a person in case the person is lost or unable to communicate in a language of a current geographical location. The information carrier device 501 may also be used, for example, by children or old and infirm people who cannot communicate their whereabouts to seek directions. Furthermore, the information carrier device 501 can be used to access identification information of a person in case of casualty care when it is not possible to identify the patient by physical examination alone.

In another example, the information carrier device 501 and the method disclosed herein are used in remote and rural areas that do not have a well established medical facility 509 available in the vicinity. In such a scenario, it may not be possible for a trained medical professional to treat the patient and document the condition of the patient in medical terms. Moreover, the geographical location and infrastructure of the area may impede quick access to a possible online treatment. Preliminary treatment provided to a patient and observations made on the medical condition of the patient can be recorded using the system 500 disclosed herein and further analyzed when the patient is wheeled in to an established medical facility 509. In another example, the information carrier device 501 may be used by pharmacists who can record medical information such as prescription details and drugs sold to a patient and input this information to the information carrier device 501. Besides updating the medical records of the patient, the method and system 500 disclosed herein can also come in handy while claiming medical insurance.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire and fiber optics, including wires that constitute a system bus coupled to a processor. Common forms of computer readable media comprise, for example, a floppy disk, a flexible disk, a hard disk, magnetic tape, any other magnetic medium, a compact disc-read only memory (CD-ROM), a digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors or like devices. Typically, a processor receives instructions from a memory or like device and executes those instructions, thereby performing one or more processes defined by those instructions. Further, programs that implement such methods and algorithms may be stored and transmitted using a variety of media, for example, the computer readable storage media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as object code. The computer program product disclosed herein comprises computer executable instructions embodied in a non-transitory computer readable storage medium, wherein the computer program product comprises computer program codes for implementing the processes of various embodiments.

Where databases are described such as the medical information database 505f, the sound model database 1102, etc., it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment including a computer that is in communication with one or more devices via a communication network. The computer may communicate with the devices directly or indirectly, via a wired medium or a wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, Sun® processors, IBM® processors, etc., that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

We claim:

1. A method for documenting and managing patient information in real time for accurate medical examination and treatment of a patient, comprising:
providing an information carrier device to said patient;
storing said patient information of said patient in said information carrier device;
extracting said stored patient information from said information carrier device by a data extraction unit that electronically communicates with said information carrier device, wherein said data extraction unit transmits said extracted patient information to a patient information processing system;
recording observational data comprising medical examination information and information on said treatment prescribed for said patient, using a recording unit associated with one or more of said information carrier device and said patient information processing system that electronically communicates with said information carrier device, wherein said recorded observational data is extracted from said recording unit by said patient information processing system;
processing and analyzing said patient information received from one or more of said information carrier device and said data extraction unit, and said recorded observational data extracted from said recording unit, by said patient information processing system;
generating a medical examination report in one or more of a plurality of formats based on said processing and said analysis of said patient information received from said one or more of said information carrier device and said data extraction unit, and said recorded observational data extracted from said recording unit, by said patient information processing system; and
transmitting said generated medical examination report in said one or more of said formats to said information carrier device by said patient information processing system for updating said patient information in said information carrier device;
whereby said generation of said medical examination report in said one or more of said formats and said updation of said patient information in said information carrier device enable said documentation and said management of said patient information in real time for said accurate medical examination and said treatment of said patient.

2. The method of claim 1, wherein said data extraction unit and said patient information processing system electronically communicate with said information carrier device by one of a wired mode of communication, a wireless mode of communication via a communication network, and a combination thereof.

3. The method of claim 1, wherein said data extraction unit electronically communicates with said patient information processing system by one of a wired mode of communication, a wireless mode of communication via a communication network, and a combination thereof.

4. The method of claim 1, further comprising securing said patient information and said generated medical examination report by a security unit provided in said information carrier device, said data extraction unit, and said patient information processing system.

5. The method of claim 1, further comprising recognizing and transforming one or more of audio content, video content, text content, audiovisual content, image content, multimedia content, and any combination thereof, from said recorded observational data into one or more of a plurality of content formats by one or more of said recording unit and said patient information processing system.

6. The method of claim 1, wherein said patient information processing system automatically fills said medical examination report and predefined forms using said patient information received from said one or more of said information carrier device and said data extraction unit, and said recorded observational data extracted from said recording unit.

7. The method of claim 1, further comprising directly extracting said patient information from said information carrier device by said patient information processing system.

8. The method of claim 1, further comprising improving signal-to-noise ratio and suppressing background noise of said recorded observational data.

9. The method of claim 1, further comprising provisioning said information carrier device with said recording unit and one or more interface elements, wherein said one or more interface elements enable activation of said recording unit for said recording and playback of said observational data.

10. The method of claim 1, wherein said recording unit is configured to establish bidirectional remote communication with a remote medical facility to transmit said recorded observational data to said remote medical facility and receive instructions from said remote medical facility to determine triage information for said patient, wherein said recording unit stores said triage information in said information carrier device via one of a wired mode of communication, a wireless mode of communication via a communication network, and a combination thereof.

11. The method of claim 10, wherein said recording unit performs one or more of echo cancellation, audio compression and decompression, image compression and decompression, and video compression and decompression of said recorded observational data for establishing said bidirectional remote communication between said recording unit and said remote medical facility.

12. The method of claim 1, further comprising providing a data storage unit in said information carrier device, wherein said data storage unit stores said patient information, said generated medical examination report, information on medical situations, and triage information, in one or more of a plurality of formats in said information carrier device, wherein said data storage unit is accessible via a user interface through one or more of an audio based access and manual access for enabling said accurate medical examination and said treatment of said patient.

13. The method of claim 1, further comprising providing a knowledge base accessible via one or more of said information carrier device and a communication network, wherein said knowledge base stores information on medical situations and triage information in one or more of a plurality of formats accessible through one or more of an audio based access and manual access for enabling said accurate medical examination and said treatment of said patient.

14. The method of claim 13, further comprising:
receiving a query from a responder for instructions on said treatment of said patient by said information carrier device;
performing data recognition on said query for extracting keywords from said query by said information carrier device; and
performing a search for said triage information in said knowledge base by said information carrier device using said extracted keywords, wherein said triage information is rendered in one or more of a plurality of formats on a user interface of said information carrier device for enabling prioritized said treatment of said patient.

15. The method of claim 1, further comprising monitoring biomedical signals of said patient by said information carrier device for verifying vital signs of said patient and biometrically tracking identity of said patient.

16. The method of claim 1, further comprising generating an alarm notification by said information carrier device during one or more of detecting a divergence of vital signs of said patient from preconfigured settings in said information carrier device, detecting a loss of signal contact between said information carrier device and external responder devices, and detecting a misassociation between said information carrier device and said patient.

17. The method of claim 1, further comprising selectively extracting information on health conditions and said treatment administered to said patient from each said recording of said observational data by said patient information processing system for generating a health record for said each said recording of said observational data.

18. The method of claim 17, further comprising integrating said selectively extracted information across a plurality of recordings of said observational data of said patient by said patient information processing system for ensuring that implicit information recorded on said health conditions and said treatment administered to said patient in one or more of said recordings of said observational data is explicitly recorded in each said generated health record.

19. The method of claim 17, further comprising extracting keywords from said observational data, tagging said extracted keywords to said generated health record associated with said observational data, and storing said generated health record and said observational data in a medical information database of said patient information processing system and a data storage unit of said information carrier device for enabling an expedited retrieval of said generated health record and said observational data using said keywords.

20. The method of claim 19, further comprising collating a plurality of health records of a plurality of patients stored in said medical information database of said patient information processing system based on said extracted keywords for tracking injuries of said patients and medical reactions to said treatment and medicines administered to said patients.

21. The method of claim 1, further comprising transmitting said generated medical examination report in said one or more of said formats to a remote medical facility by said patient information processing system via a communication network for updating said patient information at said remote medical facility.

22. The method of claim 1, further comprising extracting said updated patient information from said information carrier device by a remote medical facility via a communication network for updating said patient information at said remote medical facility.

23. The method of claim 1, further comprising automatically appending timestamps to said recorded observational data during said recording of said observational data by said recording unit associated with said one or more of said information carrier device and said patient information processing system, and converting said appended timestamps to an audio format to enable audio playback of said appended timestamps along with said recorded observational data.

24. A system for documenting and managing patient information in real time for accurate medical examination and treatment of a patient, comprising:
an information carrier device comprising a data storage unit that stores said patient information of said patient, a medical examination report, information on medical situations, and triage information in one or more of a plurality of formats;
a data extraction unit in electronic communication with said information carrier device and a patient information processing system, wherein said data extraction unit comprises:
an extraction module that extracts said stored patient information from said information carrier device; and
a communication module that transmits said extracted patient information to said patient information processing system;
a recording unit associated with one or more of said information carrier device and said patient information processing system, wherein said recording unit comprises a record and playback unit that records and plays back observational data comprising medical examination information and information on said treatment prescribed for said patient; and
said patient information processing system, in electronic communication with said information carrier device, said data extraction unit, and said recording unit, comprising:
a communication module that receives said patient information from one or more of said information carrier device and said data extraction unit, and said recorded observational data from said record and playback unit of said recording unit;
a processing and analysis unit that processes and analyzes said received patient information and said received observational data; and
a report generation module that generates said medical examination report in one or more of a plurality of formats based on said processing and said analysis of said received patient information and said received
observational data, wherein said communication module of said patient information processing system transmits said generated medical examination report in said one or more of said formats to said information carrier device for updating said patient information in said information carrier device.

25. The system of claim 24, further comprising a security unit in one or more of said information carrier device, said data extraction unit, and said patient information processing system, wherein said security unit secures said patient information and said generated medical examination report.

26. The system of claim 24, wherein said information carrier device further comprises a communication interface that interfaces with said data extraction unit, said patient information processing system, external responder devices, and remote medical facilities that extract said patient information from said information carrier device.

27. The system of claim 24, wherein said information carrier device further comprises one or more of:
a monitoring module that monitors biomedical signals of said patient for verifying vital signs of said patient and biometrically tracking identity of said patient; and
an alarm notification module that generates an alarm notification during one or more of detecting a divergence of said vital signs of said patient from preconfigured settings in said information carrier device, detecting a loss of signal contact between said information carrier device and external responder devices, and detecting a misassociation between said information carrier device and said patient.

28. The system of claim 24, wherein said processing and analysis unit of said patient information processing system further comprises a selective extraction module that performs one or more of:
selectively extracting information on health conditions and said treatment administered to said patient from each said recording of said observational data, wherein said report generation module of said patient information processing system generates a health record in one or more of a plurality of formats for said each said recording of said observational data;
integrating said selectively extracted information across a plurality of recordings of said observational data of said patient for ensuring that implicit information recorded on said health conditions and said treatment administered to said patient in one or more of said recordings of said observational data is explicitly recorded in each said generated health record; and
extracting keywords from said observational data, tagging said extracted keywords to said generated health record associated with said observational data, and storing said generated health record and said observational data in a medical information database of said patient information processing system and said data storage unit of said information carrier device for enabling an expedited retrieval of said generated health record and said observational data using said keywords.

29. The system of claim 24, further comprising a data enhancement unit in one or more of said information carrier device, said recording unit, and said processing and analysis unit, wherein said data enhancement unit improves signal-to-noise ratio and suppresses background noise of said recorded observational data.

30. The system of claim 24, further comprising a data recognition module in one or more of said recording unit and said processing and analysis unit, wherein said data recognition module recognizes and transforms one or more of audio content, video content, text content, audiovisual content, image content, multimedia content, and any combination thereof, from said recorded observational data into one or more of a plurality of content formats.

31. The system of claim 24, further comprising a knowledge base accessible via one or more of said data storage unit of said information carrier device and a communication network, wherein said knowledge base stores information on medical situations and triage information in one or more of a plurality of formats accessible through one or more of an audio based access and manual access for enabling said accurate medical examination and said treatment of said patient.

32. The system of claim 24, wherein said recording unit associated with said information carrier device performs:
receiving a query from a responder for instructions on said treatment of said patient;
data recognition on said query for extracting keywords from said query; and
performing a search for said triage information in a knowledge base using said extracted keywords, wherein said triage information is rendered in one or more of a plurality of formats on a user interface of said information carrier device for enabling prioritized said treatment of said patient.

33. The system of claim 24, wherein said report generation module of said patient information processing system automatically fills said medical examination report and predefined forms using said patient information received from said one or more of said information carrier device and said data extraction unit, and said recorded observational data extracted from said recording unit.

34. The system of claim 24, wherein said recording unit is a standalone unit that communicates with said patient information processing system by one of a wired mode of communication, a wireless mode of communication via a communication network, and a combination thereof.

35. The system of claim 24, wherein said recording unit is integrated in said patient information processing system for said recording and said playback of said observational data.

36. The system of claim 24, wherein said information carrier device further comprises:
said recording unit that directly records said observational data of said patient and plays back said directly recorded observational data of said patient; and
one or more interface elements that activate said recording unit for said recording and said playback of said observational data.

37. The system of claim 24, wherein said recording unit comprises an array of sound sensors positioned in an arbitrary configuration for receiving said observational data of said patient.

38. The system of claim 24, wherein said information carrier device is configured as a non-volatile memory card that stores said patient information independent of power and is wearable by said patient.

39. The system of claim 24, wherein said recording unit further comprises a communication module that establishes bidirectional remote communication with a remote medical facility to transmit said recorded observational data to said remote medical facility and receive instructions from said remote medical facility to determine triage information for said patient, wherein said recording unit stores said triage information in said information carrier device via one of a wired mode of communication, a wireless mode of communication via a communication network, and a combination thereof.

40. An information carrier device for documenting and managing patient information in real time for accurate medical examination and treatment of a patient, comprising:
a data storage unit that stores said patient information of said patient, a medical examination report, information on medical situations, and triage information in one or more of a plurality of formats;
a recording unit that records observational data comprising medical examination information and information on said treatment prescribed for said patient;
a monitoring module that monitors biomedical signals of said patient for verifying vital signs of said patient and biometrically tracking identity of said patient;
a communication interface that enables communication of said patient information, said recorded observational data, and said biomedical signals to one or more of a data extraction unit and a patient information processing system, wherein said data extraction unit and said patient information processing system are in electronic communication with said information carrier device by one of a wired mode of communication, a wireless mode of communication via a communication network, and a combination thereof; and
said communication interface that receives a medical examination report generated by said patient information processing system in one or more of a plurality of formats based on processing and analysis of said patient information, said recorded observational data, and said biomedical signals by said patient information processing system, wherein said data storage unit stores said generated medical examination report in said one or more of said formats.

41. The information carrier device of claim 40, further comprising an alarm notification module that generates an alarm notification during one or more of detecting a divergence of vital signs of said patient from preconfigured settings in said information carrier device, detecting a loss of signal contact between said information carrier device and external responder devices, and detecting a misassociation between said information carrier device and said patient.

42. The information carrier device of claim 40, wherein said recording unit performs:
receiving a query from a responder for instructions on said treatment of said patient;
data recognition on said query for extracting keywords from said query; and
performing a search for said triage information in a knowledge base using said extracted keywords, wherein said triage information is rendered in one or more of a plurality of formats on a user interface of said information carrier device for enabling prioritized said treatment of said patient.

43. A computer program product comprising computer executable instructions embodied in a non-transitory computer readable storage medium, wherein said computer program product comprises:
a first computer program code for extracting patient information from one or more of an information carrier device and a data extraction unit by a patient information processing system by one of a wired mode of communication, a wireless mode of communication via a communication network, and a combination thereof;
a second computer program code for receiving observational data comprising medical examination information and information on treatment prescribed for a patient, recorded using a recording unit by said patient information processing system by one of a wired mode of communication, a wireless mode of communication via a communication network, and a combination thereof;
a third computer program code for processing and analyzing said extracted patient information and said recorded observational data by said patient information processing system;
a fourth computer program code for generating a medical examination report in one or more of a plurality of formats based on said processing and said analysis of said extracted patient information and said recorded observational data by said patient information processing system; and
a fifth computer program code for transmitting said generated medical examination report in said one or more of said formats to said information carrier device by said patient information processing system by one of a wired mode of communication, a wireless mode of communication via a communication network, and a combination thereof for updating said patient information in said information carrier device;
whereby said generation of said medical examination report in said one or more of said formats and said updation of said patient information in said information carrier device enable documentation and management of said patient information in real time for accurate medical examination and treatment of said patient.

44. The computer program product of claim 43, further comprising one or more of:
a sixth computer program code for selectively extracting information on health conditions and said treatment administered to said patient from each said recording of said observational data for generating a health record for said each said recording of said observational data;
a seventh computer program code for extracting keywords from said observational data, tagging said extracted keywords to said generated health record associated with said observational data, and storing said generated health record and said observational data in a medical information database for enabling an expedited retrieval of said generated health record and said observational data using said keywords; and
an eighth computer program code for collating a plurality of health records of multiple patients stored in said medical information database based on said keywords for tracking injuries of said patients and medical reactions to said treatment and medicines administered to said patients.
